(19) United States
(12) Patent Application Publication
(10) Pub. No.: US 2026/0091606 A1
(43) Pub. Date: Apr. 2, 2026

(54) TAPE CASSETTE INCLUDING TAPE ROLL, RIBBON SPOOL, RIBBON TAKE-UP SPOOL, HOUSING INCLUDING PARTITION PLATE AND ARM, FIRST GEAR, AND SECOND GEAR

(71) Applicant: BROTHER KOGYO KABUSHIKI KAISHA, Nagoya (JP)

(72) Inventor: Shinji UKAI, Kiyosu (JP)

(21) Appl. No.: 19/333,587

(22) Filed: Sep. 19, 2025

(30) Foreign Application Priority Data
Sep. 30, 2024 (JP) 2024-171785

(51) Int. Cl. B41J 32/00; B41J 3/407; B41J 33/22; B41J 35/04; B41J 35/38

(52) U.S. Cl. CPC B41J 32/00; B41J 3/4075; B41J 33/22; B41J 35/04; B41J 35/38

(57) ABSTRACT

A tape cassette includes: a tape roll in which a tape is wound; a ribbon spool about which an ink ribbon is wound; a ribbon take-up spool configured to take up the ink ribbon; a housing having a first opening; a first gear configured to transmit a drive force to the ribbon take-up spool; and a second gear configured to operate in response to an operation of the first gear. The housing includes: a partition plate partitioning an internal space of the housing into a first space in which the tape roll and the ribbon spool are positioned and a second space in which the first gear and the second gear are positioned; and an arm having a second opening allowing the tape and the ink ribbon to be discharged through the second opening to an outside of the housing.

### REFERENCE TO RELATED APPLICATIONS

This application claims priority from Japanese Patent Application No. 2024-171785 filed on Sep. 30, 2024. The entire content of the priority application is incorporated herein by reference.

### BACKGROUND ART

There has been known a tape cassette accommodating a tape spool, a ribbon spool, and a ribbon take-up spool in a housing of the tape cassette. A tape is wound about the tape spool. An ink ribbon is wound about the ribbon spool. The ribbon take-up spool is configured to take up the used ink ribbon to collect the same.

In the tape cassette described above, the tape spool, the tape, the ribbon spool, the ribbon take-up spool, and the ink ribbon are positioned in a space in the housing.

### SUMMARY

In addition to the tape and the ink ribbon, it is further desirable to arrange gears inside the housing of the tape cassette.

In view of the foregoing, it is an object of the present disclosure to provide a tape cassette in which gears can be arranged inside a housing in addition to a tape and an ink ribbon.

In order to attain the above and other object, the present disclosure provides a tape cassette including: a tape roll in which a tape is wound; a ribbon spool about which an ink ribbon is wound; a ribbon take-up spool; a housing; a first gear; and a second gear. The ribbon spool is rotatable about a first axis extending in a first direction. The ribbon take-up spool is configured to take up the ink ribbon. The housing has a first opening. The housing includes: a partition plate; and an arm. The partition plate partitions an internal space of the housing into a first space in which the tape roll and the ribbon spool are positioned and a second space. The first space and the second space are arranged in the first direction. The arm is positioned on an opposite side of the partition plate from the first space in the first direction. The arm has a second opening allowing the tape and the ink ribbon to be discharged through the second opening to an outside of the housing. The first gear is positioned in the second space. The first gear is configured to transmit a drive force to the ribbon take-up spool. The second gear is positioned in the second space. The second gear is exposed to the outside of the housing through the first opening. The second gear is configured to operate in response to an operation of the first gear.

In the above structure, the first gear and the second gear are positioned in the second space. Accordingly, the tape cassette can secure a space for accommodating gears.

According to another aspect, the present disclosure also provides a tape cassette including: a tape roll in which a tape and an ink ribbon are wound together in an overlaid state; a ribbon take-up spool; a housing; a first gear; and a second gear. The ribbon take-up spool is rotatable about a first axis extending in a first direction. The ribbon take-up spool is configured to take up the ink ribbon. The housing has a first opening. The housing includes: a partition plate; and an arm. The partition plate partitions an internal space of the housing into a first space in which the tape roll and the ribbon take-up spool are positioned and a second space. The first space and the second space are arranged in the first direction. The arm is positioned on an opposite side of the partition plate from the first space in the first direction. The arm has a second opening allowing the tape and the ink ribbon to be discharged through the second opening to an outside of the housing. The first gear is positioned in the second space. The first gear is configured to transmit a drive force to the ribbon take-up spool. The second gear is positioned in the second space. The second gear is exposed to the outside of the housing through the first opening. The second gear is configured to operate in response to an operation of the first gear.

In the above structure, the first gear and the second gear are positioned in the second space. Accordingly, the tape cassette can secure a space for accommodating gears.

According to still another aspect, the present disclosure also provides a tape cassette including: a tape roll in which a tape is wound; a ribbon spool about which an ink ribbon is wound; a ribbon take-up spool; a housing; a first gear; and a second gear. The ribbon spool is rotatable about a first axis extending in a first direction. The ribbon take-up spool is configured to take up the ink ribbon. The housing has a first opening. The housing includes: a partition plate; and an arm. The partition plate partitions an internal space of the housing into a first space in which the tape roll, the ribbon spool, and the ribbon take-up spool are positioned and a second space. The first space and the second space are arranged in the first direction. The arm is positioned on an opposite side of the partition plate from the first space in the first direction. The arm has a second opening allowing the tape and the ink ribbon to be discharged through the second opening to an outside of the housing. The first gear is positioned in the second space.

The first gear is configured to transmit a drive force to the ribbon take-up spool. The first gear includes a first cam. The second gear is positioned in the second space. The second gear is exposed to the outside of the housing through the first opening. The second gear is configured to operate in response to an operation of the first gear. The housing further has a third opening in communication with the first space. The first cam is visible from outside the housing through the third opening.

In the above structure, the first gear and the second gear are positioned in the second space. Accordingly, the tape cassette can secure a space for accommodating gears.

### BRIEF DESCRIPTION OF DRAWINGS

FIG. 1 is a perspective view of a printer 1.

FIG. 2 is a perspective view of a tape cassette 100A, and the printer 1 in which a cover 3 has been removed from a housing 2.

FIG. 3 is a perspective view of a printing unit 50.

FIG. 4 is a perspective view of a platen unit 80 in which parts before assembly are illustrated with two-dot chain lines.

FIG. 5 is a front view of a drive shaft 63.

FIG. 6 is an exploded perspective view of the drive shaft 63.

FIG. 7 is an exploded perspective view of the tape cassette 100A.

FIG. 8 is a perspective view of the tape cassette 100A, and illustrating a second space S2.

FIG. 9 is a perspective view of a fourth gear 32 on which a torque limiter 58 is mounted.

FIG. 10 is a view of the torque limiter 58 when viewed in an AW direction in FIG. 9.

FIG. 11 is a cross-sectional view of the tape cassette 100A taken along a line XI-XI in FIG. 12.

FIG. 12 is a plan view of the tape cassette 100A, and illustrating a first space S1 and the second space S2.

FIG. 13 is a plan view of the tape cassette 100A, and illustrating the first space S1.

FIG. 14 is an exploded perspective view of a tape cassette 100B.

FIG. 15 is a perspective view of the tape cassette 100B, and illustrating the second space S2.

FIG. 16 is a plan view of the tape cassette 100B, and illustrating the first space S1 and the second space S2.

FIG. 17 is a perspective view of the fourth gear 32 on which the torque limiter 58 is mounted.

FIG. 18 is a cross-sectional view of the tape cassette 100B taken along a line XVIII-XVIII in FIG. 16.

FIG. 19 is a perspective view of a tape roll 411 in which a tape 40 and an ink ribbon 43 are wound together in an overlaid state.

FIG. 20 is a plan view of the tape cassette 100B, and illustrating the first space S1.

FIG. 21 is an exploded perspective view of a tape cassette 100C.

FIG. 22 is a perspective view of the tape cassette 100C, and illustrating the second space S2.

FIG. 23 is a plan view of the tape cassette 100C, and illustrating the first space S1 and the second space S2.

FIG. 24 is a plan view of the tape cassette 100C, and illustrating the first space S1.

### DESCRIPTION

Hereinafter, a printer 1 and a tape cassette 100A according to an embodiment of the present disclosure will be described while referring to the accompanying drawings. The drawings are used to describe the technical features made possible with the present disclosure. In other words, the configurations and the like illustrated in the drawings are merely illustrative examples and are not intended to limit the present disclosure.

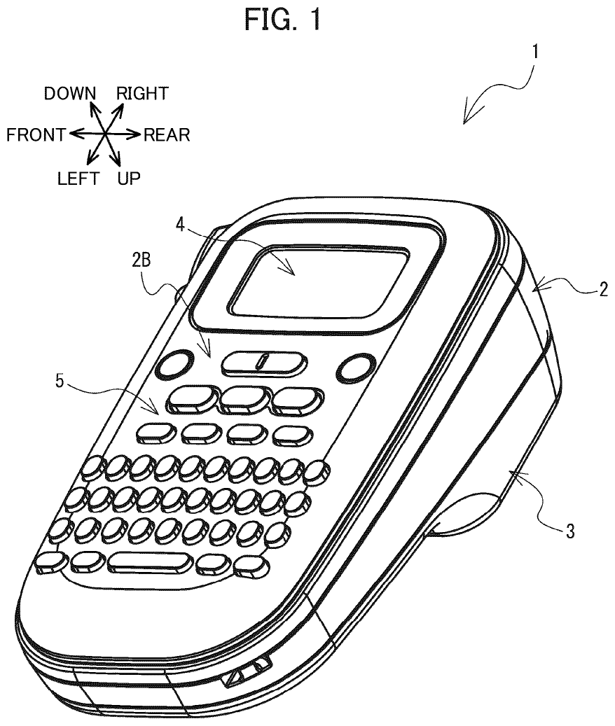

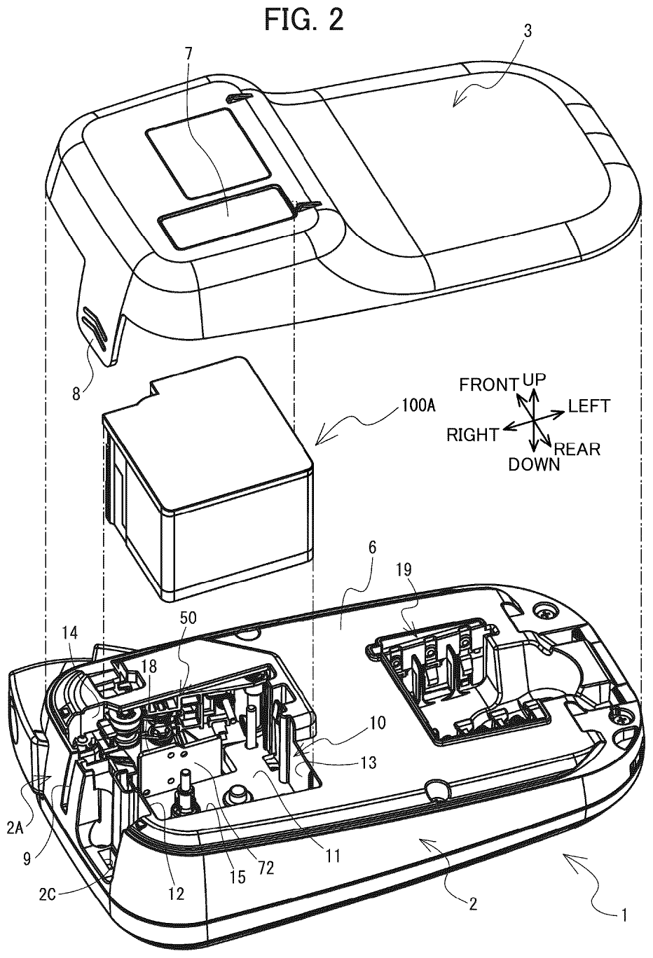

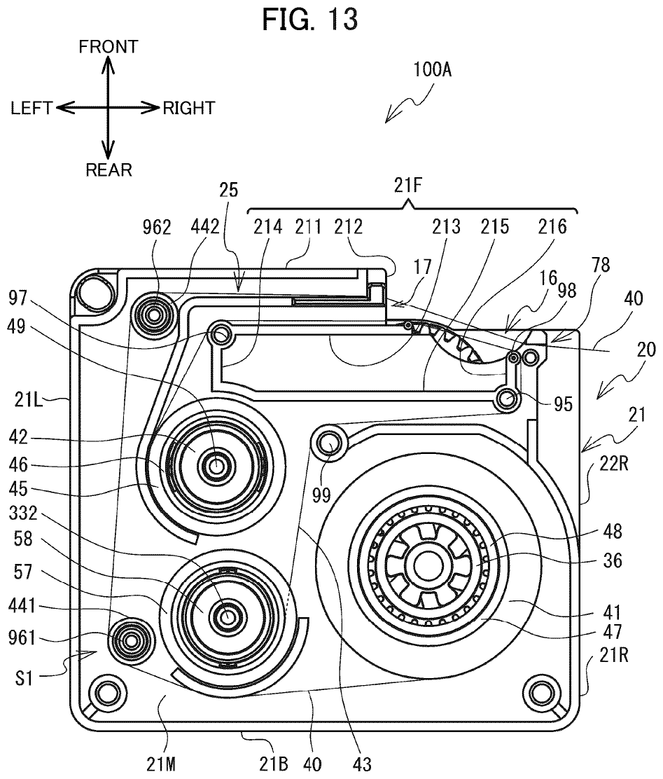

The configuration of the printer 1 will be described. As illustrated in FIGS. 1 and 2, the printer 1 is a portable label printer. The printer 1 is configured to print images on a tape 40 illustrated in FIG. 13 to create labels. Specifically, the printer 1 is configured to print images, such as characters and figures, on the tape 40.

As illustrated in FIGS. 1 and 2, the printer 1 includes a housing 2, a cover 3, a display unit 4, and an input unit 5.

The housing 2 has a box shape and is elongated in a left-right direction. The housing 2 has an upper surface that is formed with an opening. An inner cover 6 is assembled over the opening, thereby protecting an inside of the housing 2. A right wall 2A of the housing 2 has a discharge channel 9, and an anchoring hole 2C. The discharge channel 9 extends through the right wall 2A in the left-right direction. The anchoring hole 2C is in engagement with an opening/closing unit 8 of the cover 3.

The cover 3 is mounted on the housing 2 so as to be removable from the housing 2. The cover 3 is elongated in the left-right direction. In a state where the cover 3 is mounted on the housing 2, a part of the cover 3 that faces the housing 2 is concaved toward the housing 2. Also, in the state where the cover 3 is mounted on the housing 2, the cover 3 covers the entirety of the upper surface of the housing 2 which includes the opening formed in the upper surface of the housing 2 and the inner cover 6.

A right end portion of the cover 3 includes a window 7. The window 7 is positioned in line with a rear end of a cassette attachment portion 10. Through the window 7, the user can see a label affixed to an upper surface of the tape cassette 100A, for example. The label specifies the type of the tape 40, for example.

The display unit 4 is a liquid crystal display, for example, and is configured to display various information. The display unit 4 is disposed on a right end portion of a lower surface 2B of the housing 2.

The input unit 5 is configured to receive various information inputted through user operations. The input unit 5 is disposed on a left portion of the bottom surface 2B of the housing 2. In other words, the input unit 5 is arranged at a position leftward of the display unit 4. The input unit 5 includes various keys such as character keys, a Print button, and an Esc key.

As illustrated in FIG. 2, inside the housing 2, the printer 1 includes the cassette attachment portion 10, a battery accommodating portion 19, and a printing unit 50.

The tape cassette 100A is attachable to and detachable from the cassette attachment portion 10. The cassette attachment portion 10 is arranged at a position further rightward relative to a left-right center of the inner cover 6. The cassette attachment portion 10 is recessed downward. The cassette attachment portion 10 has a bottom surface 11, and peripheral walls 12 to 15. The peripheral walls 12 to 15 are connected to edges of the bottom surface 11 to surround the bottom surface 11 in a front-rear direction and the left-right direction.

The battery accommodating portion 19 is configured to accommodate a battery (not illustrated). The battery accommodating portion 19 is arranged on the inner cover 6 at a position further leftward relative to a left-right center of the housing 2 and is recessed downward.

In a state where the cover 3 is removed from the housing 2, the cassette attachment portion 10 and the battery accommodating portion 19 are exposed to an outside of the printer 1. Therefore, the user can replace the tape cassette 100A and the battery by removing the cover 3 from the housing 2.

The printing unit 50 is configured to perform printing on the tape 40. The printing unit 50 is arranged in a lower portion on a front end portion of the cassette attachment portion 10, i.e., in a front portion inside the housing 2.

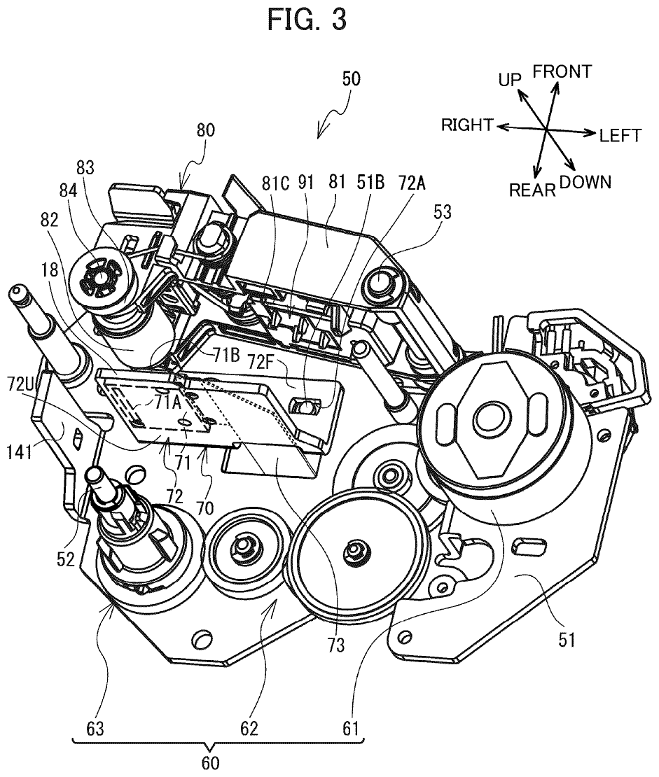

As illustrated in FIG. 3, the printing unit 50 includes a base 51, a head unit 70, a platen unit 80, and a drive mechanism 60.

As illustrated in FIG. 3, the base 51 supports components of the printing unit 50. The base 51 is a metal plate. The base 51 has plate surfaces that face in opposite directions in an up-down direction. A dimension of the base 51 in the left-right direction is greater than a dimension of the base 51 in the front-rear direction. The base 51 includes a mounting portion 141, a pin 51B, and a shaft 52.

The printer 1 also includes a cutter (not illustrated). The cutter includes a cutting blade and a cutting plate. In response to a user operation, the cutter cuts the tape 40 between the cutting blade and the cutting plate.

The mounting portion 141 is positioned on a right end of a front-rear center of the base 51. The mounting portion 141 extends upward from the base 51. The mounting portion 141 has plate surfaces that face opposite directions in the left-right direction. The mounting portion 141 is a metal plate. The mounting portion 141 supports the cutting plate of the cutter (not illustrated).

The pin 51B is arranged on a center of the base 51. The pin 51B extends upward from the base 51. The pin 51B has a columnar shape. Note that another pin (not illustrated) is arranged at a position rightward of the pin 51B. The other pin (not illustrated) has a configuration that is identical to that of the pin 51B. The shaft 52 is disposed on a right-rear portion of the base 51. The shaft 52 extends upward from the base 51.

As illustrated in FIG. 3, the head unit 70 is assembled to the base 51. The head unit 70 includes a heat sink 72, and a print head 71.

The heat sink 72 holds the print head 71. The heat sink 72 is a metal plate for dissipating heat from the print head 71. The heat sink 72 is disposed on a right end portion of the front-rear center of the base 51. The heat sink 72 includes a first plate 72F, and a second plate 72U.

The first plate 72F is elongated in the left-right direction. The first plate 72F has plate surfaces that face opposite directions in the up-down direction. A hole 72A is formed in the first plate 72F. The hole 72A extends through the first plate 72F in the up-down direction. Another hole (not illustrated) is also formed in the first plate 72F. The other hole (not illustrated) is formed at a position rightward of the hole 72A. The hole (not illustrated) has a configuration that is identical to that of the hole 72A.

The pin 51B is inserted in the hole 72A. The other pin (not illustrated) is inserted in the other hole (not illustrated). In this state, the first plate 72F is fixed to the base 51 with a screw (not illustrated).

The second plate 72U extends upward from a rear edge of the first plate 72F. The second plate 72U has plate surfaces that face opposite directions in the front-rear direction. A dimension of the second plate 72U in the left-right direction is greater than a dimension of the second plate 72U in the up-down direction. In a state where the tape cassette 100A is attached to the printer 1, an upper surface of a right end portion of the second plate 72U functions as a support part 18 for supporting the tape cassette 100A.

The print head 71 is fixed to a front surface of the second plate 72U of the heat sink 72 with adhesive. The print head 71 is a rectangular circuit board on which a plurality of heating elements 71A and a driver circuit 71B are mounted. The heating elements 71A are aligned in the up-down direction on a right end portion of the circuit board. The driver circuit 71B is arranged on an upper end portion of the circuit board. The driver circuit 71B is electrically connected to a controller (not illustrated) of the printer 1 via a harness 73.

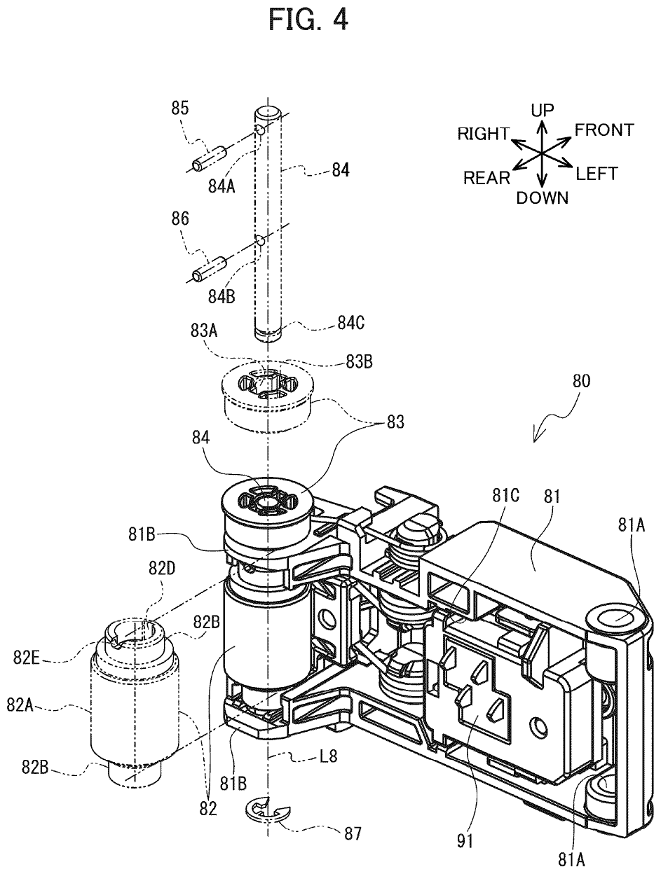

As illustrated in FIGS. 3 and 4, the platen unit 80 is disposed on a front portion of the base 51. The platen unit 80 has a left end portion supported by a rotational shaft 53. The rotational shaft 53 is disposed on a left portion of a front end portion of the base 51. The rotational shaft 53 extends upward from the base 51. The platen unit 80 has a right end portion which is pivotally movable in the front-rear direction.

Pivotal movement of the platen unit 80 causes a platen roller 82 to be moved between an adjacent position (not illustrated) and a separated position (a position illustrated in FIG. 3).

The adjacent position is a position in which the plate roller 82 is positioned close to the print head 71, and the separated position is a position in which the platen roller 82 is separated away from the print head 71.

For convenience, in the following description related to components of the platen unit 80, directions for the components of the platen unit 80 will be described based on a state where the platen roller 82 is in the adjacent position. Also, the directions for the components of the platen unit 80 will be based on the directions of the components of printer 1 described above.

The platen unit 80 includes a platen holder 81, a platen shaft 84, the platen roller 82, a platen gear 83, and a detection unit 91.

The platen holder 81 has a left end portion that is open rearward. The platen holder 81 also has a rear end portion that includes an upper wall and a lower wall. Support holes 81A are formed on the respective upper wall and the lower wall of the platen holder 81 to extend through the respective upper wall and the lower wall in the up-down direction. Specifically, the upper support hole 81A extends through the upper wall of the platen holder 81 in the up-down direction, and the lower support hole 81A extends through the lower wall of the platen holder 81 in the up-down direction. The rotational shaft 53 of the base 51 is inserted through the support holes 81A.

A platen support plate 81B is provided on a right end portion of each of the upper wall and the lower wall of the platen holder 81. The platen support plates 81B extend rearward. The platen roller 82 is rotatably supported between the platen support plates 81B.

The platen shaft 84 is a shaft extending in the up-down direction. The platen shaft 84 has an upper end portion having an insertion hole 84A, and a center in the up-down direction that having an insertion hole 84B.

Engagement pins 85 and 86 are inserted through the insertion holes 84A and 84B, respectively. Each of the engagement pins 85 and 86 has a length that is greater than a diameter of the platen shaft 84. Both ends of each of the engagement pins 85 and 86 are exposed outside the corresponding insertion holes 84A and 84B. The platen shaft 84 also has a lower end portion on which a groove 84C is formed. A retaining ring 87 is in engagement with the groove 84C.

The platen roller 82 includes a roller sleeve 82B, and a roller body 82A.

The roller sleeve 82B has a hollow cylindrical shape. The platen shaft 84 is inserted through the roller sleeve 82B. The roller sleeve 82B is rotatable together with the platen shaft 84. A notch 82E is formed on an upper end of the roller sleeve 82B at a position aligned with the position of a groove 82D. The notch 82E extends through a portion of the roller sleeve 82B in a radial direction.

The roller body 82A has a hollow cylindrical shape. The roller body 82A is fitted over a center portion of an outer circumferential surface of the roller sleeve 82B. The roller body 82A is rotatable together with the platen shaft 84 and the roller sleeve 82B. The roller body 82A is rotatable about an axis L8 of the platen shaft 84.

The platen gear 83 is fixed to the upper end portion of the platen shaft 84. The platen shaft 84 protrudes further upward relative to the platen support plate 81B on the upper wall of the platen holder 81. The platen gear 83 is a helical gear. The platen gear 83 has gear teeth that are helical (i.e., skewed) at a prescribed angle relative to the axis L8 of the platen shaft 84.

The engagement pin 85, which is inserted through the platen shaft 84, is in engagement with a groove 83B. The groove 83B is formed in an inner surface of the platen gear 83 that defines a through-hole 83A. The engagement pin 85 is configured to transmit a torque from the platen gear 83 to the platen shaft 84. Hence, the platen shaft 84 is rotatable together with the platen gear 83.

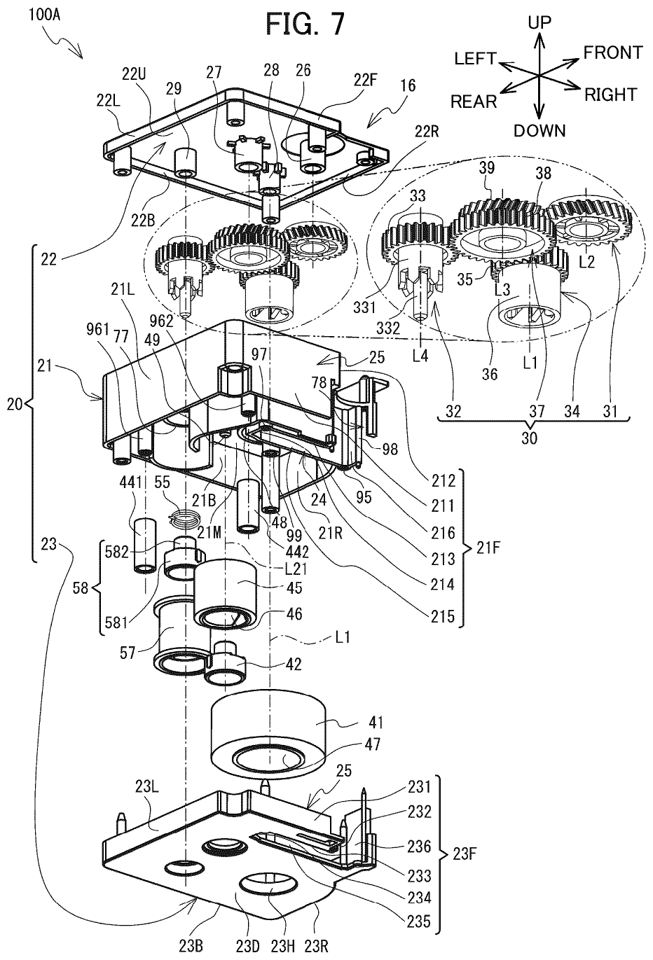

In a state where the platen roller 82 is in the adjacent position, the tape 40 and an ink ribbon 43 are to be nipped between the roller body 82A and the print head 71. The platen gear 83 is configured to engage with a second gear 31 (see FIG. 7) in the tape cassette 100A.

A drive force from a drive shaft 63 (described later) is inputted into the platen roller 82 via the tape cassette 100A and the platen gear 83. Through an axial rotation of the platen roller 82, the roller body 82A conveys the tape 40 nipped between the roller body 82A and the print head 71 toward the discharge channel 9.

As illustrated in FIG. 3, the platen holder 81 includes a holding portion 81C at a position rearward of a front-rear center of the platen holder 81. The holding portion 81C has a recessed shape that is recessed frontward. The holding portion 81C holds the detection unit 91.

The detection unit 91 includes mechanical switches. The mechanical switches of the detection unit 91 are turned on and off by detection parts (not illustrated) on the tape cassette 100A. The detection unit 91 is configured to detect cassette identification information assigned to the tape cassette 100A on the basis of the combination of on/off signals from the mechanical switches.

As illustrated in FIG. 3, the drive mechanism 60 is mounted on the base 51. The drive mechanism 60 includes a motor 61, a gear train 62, and the drive shaft 63. The motor 61, the gear train 62, and the base 51 are disposed inside the housing 2 at a position downward of the inner cover 6.

The motor 61 is a drive source of a drive transmission mechanism 30 (described later). The motor 61 is disposed on a left end portion of the base 51. The gear train 62 includes a plurality of gears coupled together for transmitting a drive force of the motor 61 to the drive shaft 63.

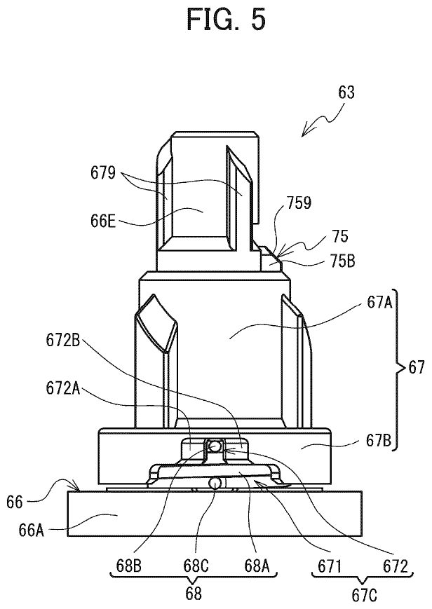

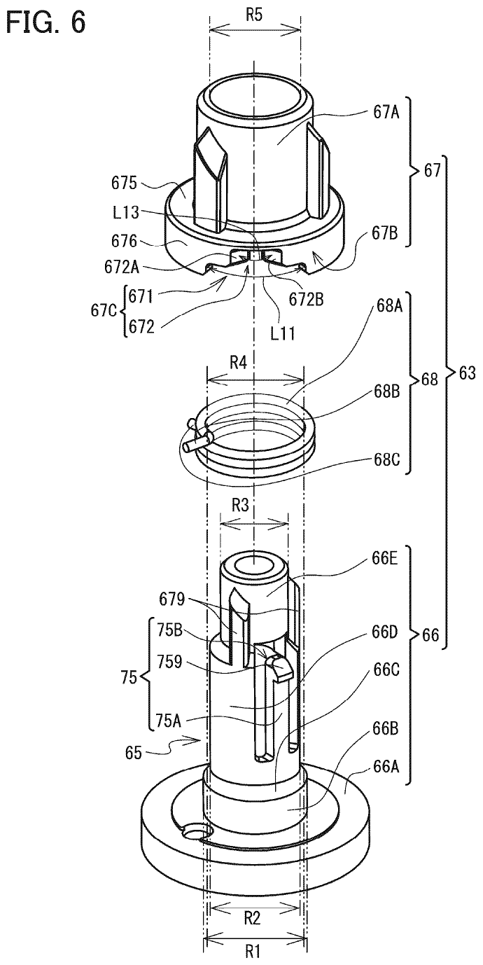

The drive shaft 63 will be described with reference to FIGS. 5 and 6. The drive shaft 63 is disposed on a right-rear corner of the base 51. The drive shaft 63 is fitted over the shaft 52 provided on the base 51. The drive shaft 63 is exposed inside the cassette attachment portion 10.

The drive shaft 63 is configured to be inserted in a first gear 34 (described later). A drive force transmitted from the motor 61 is inputted into the drive shaft 63 via the gear train 62. The drive shaft 63 is configured to rotate the first gear 34 with the drive force from the motor 61.

The drive shaft 63 includes a drive gear 66, a clutch spring 68, and a drive cam 67.

The drive force of the motor 61 is transmitted to the drive gear 66 via the gear train 62. The drive gear 66 is made of resin material, for example.

The drive gear 66 includes a gear 66A, and a shaft 65.

The gear 66A is in engagement with the most downstream gear in the gear train 62 illustrated in FIG. 3. The gear 66A is rotatable by the drive force of the motor 61 illustrated in FIG. 3 transmitted via the gear train 62. The shaft 65 extends upward from the gear 66A.

The shaft 65 has a hollow cylindrical shape. The shaft 65 has a diameter that is smaller than a diameter of the gear 66A. The shaft 65 is fitted over the shaft 52 illustrated in FIG. 3. The shaft 65 is rotatable together with the gear 66A about the shaft 52.

The shaft 65 includes a first shaft 66B, a taper 66C, a second shaft 66D, and a third shaft 66E.

The first shaft 66B extends upward from a diametrical center of the gear 66A. The first shaft 66B has a hollow cylindrical shape. An outer diameter of the first shaft 66B is constant along the up-down direction. The outer diameter of the first shaft 66B will be referred to as a first diameter R1. The taper 66C extends upward from the first shaft 66B. An outer diameter of the taper 66C decreases while extending upward.

The second shaft 66D extends upward from an upper end of the taper 66C. The second shaft 66D has a hollow cylindrical shape. An outer diameter of the second shaft 66D is constant along the up-down direction. The outer diameter of the second shaft 66D will be referred to as a second diameter R2. The second diameter R2 of the second shaft 66D is smaller than the first diameter R1 of the first shaft 66B.

A hook 75 is disposed on the second shaft 66D. Specifically, the hook 75 is disposed on a periphery of the second shaft 66D. The hook 75 is configured to position the drive cam 67 to restrict the drive cam 67 from coming off the shaft 65.

The hook 75 includes an extended portion 75A, and a protruding portion 75B.

The extended portion 75A extends upward from a lower end portion of the second shaft 66D. The extended portion 75A is flexible in a radial direction of the shaft 65.

The protruding portion 75B protrudes outward in the radial direction of the shaft 65 from an upper end of the extended portion 75A. The protruding portion 75B has a tapered surface 759. The tapered surface 759 slopes radially outward as extending downward.

In a state where the drive cam 67 (described later) is mounted on the shaft 65, the protruding portion 75B is positioned further upward relative to an upper end of the drive cam 67 and protrudes further radially outward relative to an inner wall of the drive cam 67. In this state, a lower surface of the protruding portion 75B contacts the upper end of the drive cam 67 from above, thereby restricting the drive cam 67 from coming off the shaft 65.

The third shaft 66E extends upward from the second shaft 66D. Specifically, the third shaft 66E extends upward from an upper end of the second shaft 66D. The third shaft 66E has a hollow cylindrical shape. An outer diameter of the third shaft 66E is constant along the up-down direction. The outer diameter of the third shaft 66E will be referred to as a third diameter R3. The third diameter R3 is smaller than the second diameter R2.

A transmission gear 679 extending in the up-down direction is disposed on the third shaft 66E. The third shaft 66E is configured to be inserted in the first gear 34 (described later). The third shaft 66E is configured to transmit a drive force from the motor 61 to the first gear 34 via the transmission gear 679.

The clutch spring 68 is a coil spring. The clutch spring 68 includes a body 68A, a first arm 68B, and a second arm 68C.

The body 68A is mounted over an outer circumferential surface of the first shaft 66B in the drive gear 66. The body 68A is formed in a helical shape extending in the up-down direction. In a state where the body 68A is not mounted on the drive gear 66, the body 68A has an inner diameter R4 that is smaller than the first diameter R1 and is greater than the second diameter R2. The third diameter R3 of the third shaft 66E is also smaller than the inner diameter R4 of the clutch spring 68 in a state where the clutch spring 68 is not mounted on the first shaft 66B.

The first arm 68B extends outward in the radial direction of the shaft 65 from an upper end of the body 68A. The second arm 68C extends outward in the radial direction from a lower end of the body 68A. As illustrated in FIG. 6, the second arm 68C is separated from the first arm 68B in the radial direction in a state prior to mounting the body 68A on the first shaft 66B.

Upon mounting the body 68A on the first shaft 66B, the body 68A expands to cause the inner diameter R4 of the body 68A to become the first diameter R1. Consequently, the second arm 68C is closer to the first arm 68B in the radial direction than the state prior to mounting the body 68A on the first shaft 66B.

The drive cam 67 is mounted on the shaft 65. The drive cam 67 has a hollow cylindrical shape. The drive cam 67 is made of resin material different from the drive gear 66, for example. Specifically, the drive cam 67 is made a different type or grade of resin material from the drive gear 66.

The drive cam 67 includes a cam 67A, and a spring accommodating portion 67B.

The cam 67A has a hollow cylindrical shape that extends in the up-down direction. The cam 67A has an inner diameter R5. The inner diameter R5 of the cam 67A is greater than the second diameter R2 of the second shaft 66D. The cam 67A is placed over the second shaft 66D.

The spring accommodating portion 67B is disposed on a lower end portion of the cam 67A. The spring accommodating portion 67B is placed over the first shaft 66B.

The spring accommodating portion 67B includes an upper wall 675, and a peripheral wall 676.

The upper wall 675 extends radially outward from the lower end portion of the cam 67A. In other words, the upper wall 675 has a disc shape with a through-hole extending through a center region of the upper wall 675 in the up-down direction. As illustrated in FIG. 5, the upper wall 675 covers the clutch spring 68 from above.

The peripheral wall 676 extends downward from a radial outer edge of the upper wall 675. As illustrated in FIG. 5, the peripheral wall 676 covers the clutch spring 68 from outside in the radial direction.

A notch 67C is formed on the peripheral wall 676. The notch 67C is cut upward from a lower end of the peripheral wall 676.

As illustrated in FIG. 6, the notch 67C includes a first portion 671, and a second portion 672.

A length of the first portion 671 in a circumferential direction will be referred to as a first length L11. The second portion 672 extends upward from a circumferential center of the first portion 671. A length of the second portion 672 in the circumferential direction will be referred to as a second length L13. The second length L13 is smaller than the first length L11.

The second portion 672 includes a first wall 672A, and a second wall 672B. The first wall 672A and the second wall 672B oppose each other in the circumferential direction.

The first wall 672A contacts the first arm 68B from one side in the circumferential direction, and the second wall 672B contacts the first arm 68B from the other side in the circumferential direction. As a result, the first arm 68B of the clutch spring 68 is circumferentially positioned through contact with the second portion 672.

The second arm 68C of the clutch spring 68 is positioned inside the first portion 671. The second arm 68C does not contact the first portion 671.

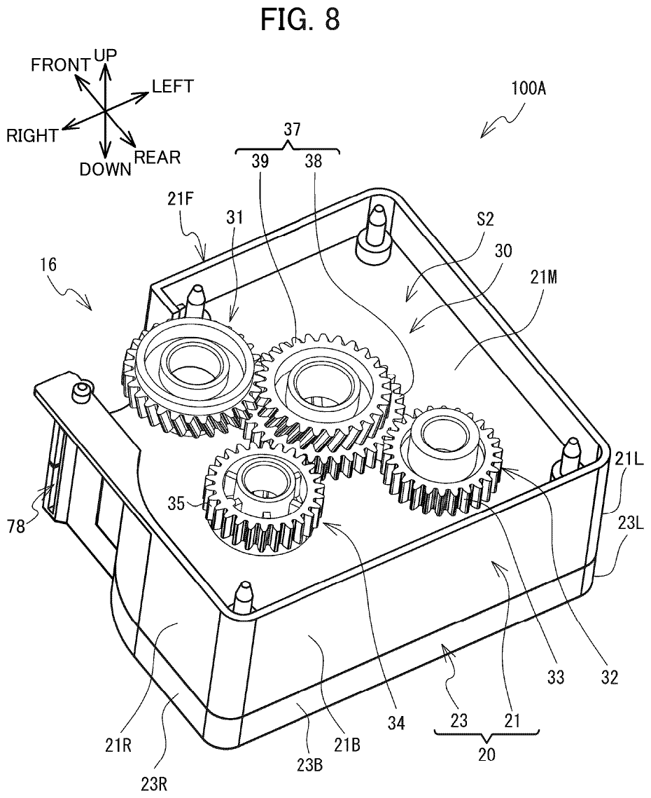

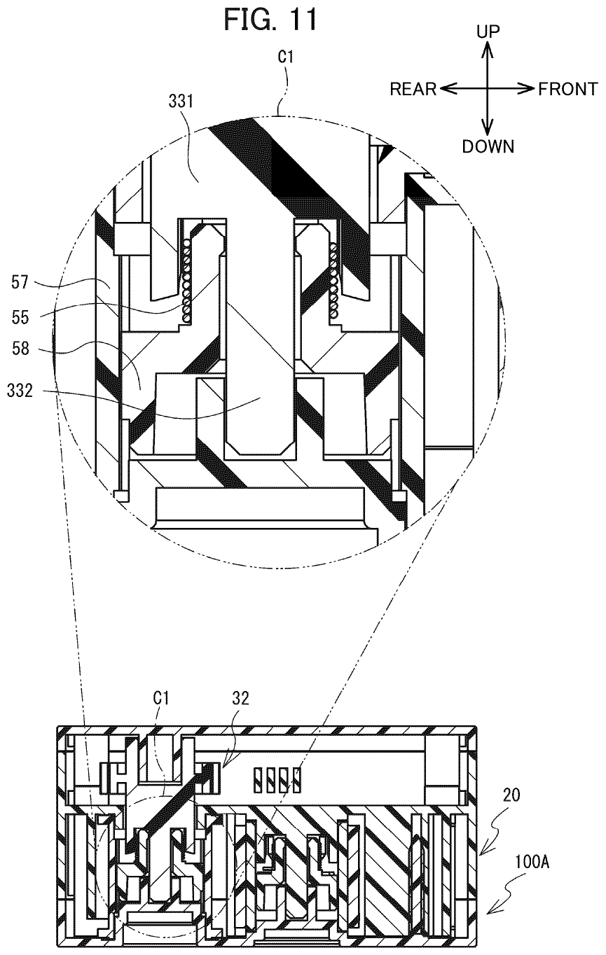

Next, the tape cassette 100A will be described with reference to FIGS. 2 and 7 through 12. The tape cassette 100A is attachable to the cassette attachment portion 10 illustrated in FIG. 2.

The tape cassette 100A includes a ribbon roll 45, a tape roll 41, and the ribbon take-up spool 57. Replenishment of the tape 40 and change of the type of the tape 40 (for example, the size, the color, and the material) can be performed by replacing the tape cassette 100A attached to the cassette attachment portion 10 of the printer 1.

The ribbon roll 45 is a roll in which the ink ribbon 43 is wound. A ribbon spool 46 (described later) is rotatable about a first rotational axis L21 extending in a first direction. In FIGS. 7 to 13, the up-down direction corresponds to the first direction. The first rotational axis L21 may correspond to a direction in which a shaft 49 (described later) extends.

The ink ribbon 43 is wound about the ribbon spool 46 to form the ribbon roll 45. Specifically, with the ink ribbon 43 wound about the ribbon spool 46, the ribbon spool 46 is rotatable about the first rotational axis L21 extending in the first direction. Therefore, the ribbon roll 45 is also rotatable about the first rotational axis L21 extending in the first direction.

The ribbon spool 46 has a hollow cylindrical shape that is elongated in the first direction. The ink ribbon 43 is a strip shape. The ink ribbon 43 is to be used for perform printing on the tape 40. The ink ribbon 43 is overlaid on the tape 40 in a head opening 24 (described later) and is used for printing by the print head 71.

The tape roll 41 is a roll in which the tape 40 is wound about the tape spool 47. The tape spool 47 is rotatable about a second rotational axis extending in the first direction. As described above, the up-down direction in FIGS. 7 to 13 corresponds to the first direction. The second rotational axis is aligned with a first axis L1 of the first gear 34 (described later).

The tape 40 is wound about the tape spool 47 to form the tape roll 41. Specifically, with the tape 40 wound about the tape spool 47, the tape spool 47 is rotatable about the second rotational axis extending in the first direction. Therefore, the tape roll 41 is also rotatable about the second rotational axis extending in the first direction.

The tape spool 47 has a hollow cylindrical shape and is elongated in the first direction. The tape 40 is a strip shape. The tape 40 includes a printing tape having adhesive coated on one surface and a releasing paper bonded to the one surface to cover the same, for example. Printing is to be performed on the tape 40 by the print head 71.

The tape roll 41 is positioned inside a housing 20 of the tape cassette 100A on one side of the housing 20 in a second direction. Note that the left-right direction in FIGS. 7 to 13 corresponds to the second direction. The ribbon roll 45 is positioned inside the housing 20 on another side of the housing 20 in the second direction. In other words, the tape spool 47 is positioned inside the housing 20 on the one side of the housing 20 in the second direction, while the ribbon spool 46 is positioned inside the housing 20 on the other side of the housing 20 in the second direction.

The ribbon take-up spool 57 is positioned inside the housing 20 on the other side of the housing 20 in the second direction. The ribbon take-up spool 57 is rotatable about a third rotational axis extending in the first direction. The third rotational axis of the ribbon take-up spool 57 is coaxial with a fourth axis L4 of a fourth gear 32 (described later). The ribbon take-up spool 57 has a hollow cylindrical shape.

As illustrated in FIG. 2, the tape cassette 100A has a rectangular parallelepiped outer shape. As illustrated in FIGS. 7, 8, 11, 12, and 13, the tape cassette 100A includes the housing 20. The housing 20 includes an arm 25. The arm 25 is positioned on one side of the housing 20 in a third direction. In other words, the arm 25 is positioned closer to one end portion on the one side of the housing 20 in the third direction than to one end portion on another side of the housing 20 in the third direction. Note that the front-rear direction in FIGS. 7 to 13 corresponds to the third direction. The arm 25 is positioned on the opposite side of a partition plate 21M (described later) from a first space S1 (described later) in the first direction. The arm 25 has a second opening 17. The second opening 17 in the arm 25 allows the tape 40 to be discharged through the second opening 17 to an outside of the housing 20.

The housing 20 includes cases 21, 22, and 23. The case 21 is positioned between the case 22 and the case 23 in the first direction. The case 22 is coupled to the case 21 on one side in the first direction. The case 23 is coupled to the case 21 on another side in the first direction.

As illustrated in FIG. 7, the case 21 includes the partition plate 21M and plates 21B, 21R, 21L, and 21F. Each of the partition plate 21M and the plates 21B, 21R, and 21L has a rectangular shape.

The partition plate 21M extends both in the second direction and in the third direction which are described above. The partition plate 21M has openings 48 and 77, and includes shafts 961 and 962, the shaft 49, and a second ribbon guide 99. The openings 48 and 77 extend through the partition plate 21M in the first direction.

The shafts 961 and 962, and the shaft 49 extend in the first direction from the partition plate 21M. The shaft 961 is positioned on the other side in the second direction of the housing 20 and near one end portion of the housing 20 on the other side in the third direction.

The shaft 962 is positioned on the other side in the second direction of the housing 20 and near one end portion of the housing 20 on the one side in the third direction.

The shaft 49 is disposed on a center of the housing 20 with respect to the third direction. The shaft 49 extends in the first direction.

The case 21 also includes a first ribbon guide 97, and the second ribbon guide 99.

The second ribbon guide 99 is disposed on a position offset from a center of the partition plate 21M. The second ribbon guide 99 extends in the first direction. The second ribbon guide 99 has a columnar shape. The first ribbon guide 97 will be described later.

The plate 21R constitutes one end portion of the case 21 on the one side of the second direction. The plate 21B constitutes one end portion of the case 21 on the other side of the third direction. The plate 21L constitutes one end portion of the case 21 on the other side of the second direction.

The plates 21F constitutes one end portion of the housing 20 on the one side in the third direction. The plates 21F include plates 211 to 216. Each of the plates 211 to 216 has a rectangular shape. The plates 211, 213, and 215 extend both in the first direction and in the second direction. The plates 212, 214, and 216 extend both in the first direction and in the third direction.

The plate 211 constitutes the one end portion of the housing 20 on the one side in the third direction. The plate 212 spans between an edge of the plate 211 and an edge of the plate 213.

Another edge of the plate 213 is connected to the first ribbon guide 97. An edge of the plate 214 is also connected to the first ribbon guide 97. In other words, the first ribbon guide 97 is disposed on the respective edges of the plates 213 and 214 which constitute the case 21. The first ribbon guide 97 extends in the first direction. The first ribbon guide 97 has a columnar shape.

An edge of the plate 215 is connected to another edge of the plate 214.

Another edge of the plate 215 is connected to a second ribbon guide 95. An edge of the plate 216 is also connected to the second ribbon guide 95. In other words, the second ribbon guide 95 is disposed on the respective edges of the plates 215 and 216 which constitute the case 21. The second ribbon guide 95 extends in the first direction. The second ribbon guide 95 has a columnar shape.

A second ribbon guide 98 is disposed on another edge of the plate 216 constituting the case 21. The second ribbon guide 98 extends in the first direction. The second ribbon guide 98 has a columnar shape.

The case 23 includes plates 23D, 23B, 23R, 23L, and 23F. Each of the plates 23D, 23B, 23R, and 23L has a rectangular shape.

As illustrated in FIG. 7, the plate 23D extends both in the second direction and in the third direction. The plate 23D has a third opening 23H. The third opening 23H extends through the plate 23D in the first direction.

The plate 23R is positioned on an edge of the plate 23D. The plate 23B is positioned on another edge of the plate 23D. The plate 23L is arranged on another edge of the plate 23D.

The plates 23F are arranged on another edge of the plate 23D. The plates 23F include plates 231 to 236. Each of the plates 231 to 236 has a rectangular shape. The plates 231, 233, and 235 extend both in the first direction and in the second direction. The plates 232, 234, and 236 extend both in the first direction and in the third direction.

The plate 231 is arranged on the other edge of the plate 23D. The plate 232 is positioned between an edge of the plate 231 and an edge of the plate 233. Another edge of the plate 233 is connected to an edge of the plate 234. Another edge of the plate 234 is connected to an edge of the plate 235. Another edge of the plate 235 is connected to an edge of the plate 236.

The arm 25 of the tape cassette 100A is defined by the cases 21 and 23. The arm 25 includes the plate 21F and the plate 23F. Specifically, the arm 25 includes the partition plate 21M and the plates 211 to 214 of the case 21 and the plate 23D and the plates 231 to 234 of the case 23.

An end portion of the arm 25 is constituted by the plate 212 of the case 21 and the plate 232 of the case 23. The second opening 17 is formed in the end portion of the arm 25. The second opening 17 extends in a width direction of the tape 40, i.e., in the first direction. The second opening 17 has a slit shape.

The housing 20 also includes a guide 78. The guide 78 has a slit. The slit extends in the first direction. The tape 40 that has been discharged through the second opening 17 of the arm 25 is conveyed to the slit in the guide 78. The guide 78 is configured to guide the tape 40 that has passed through the slit in the guide 78 to the discharge channel 9 of the printer 1.

The head opening 24 is formed between the arm 25 and the guide 78. In a state where the tape cassette 100A is attached to the cassette attachment portion 10, the head unit 70 is inserted in the head opening 24.

The first space S1 is defined by the cases 21 and 23. The first space S1 is a space enclosed by the partition plate 21M and the plates 21F, 21B, 21L, and 21R of the case 21 and the plates 23D, 23F, 23B, 23L, and 23R of the case 23. The third opening 23H is in communication with the first space S1.

The tape roll 41, the tape spool 47, the ribbon roll 45, the ribbon spool 46, the ribbon take-up spool 57, and other components such as tape guides 441 and 442 are positioned in the first space S1.

The tape spool 47 is fitted over an outer circumferential wall defining the opening 48 so as to be slidingly movable relative to the same. The second rotational axis of the tape spool 47 is coaxial with the first axis L1 of the first gear 34 (described later).

A holder 42 is fitted inside the ribbon spool 46 so as not to be rotatable relative to the ribbon spool 46. An end portion of the holder 42 is fitted over the shaft 49. The holder 42 is rotatable together with the ribbon spool 46 about the first rotational axis L21.

A torque limiter 58 is fitted inside the ribbon take-up spool 57. The torque limiter 58 connects the fourth gear 32 and the ribbon take-up spool 57 to each other. The torque limiter 58 will be described later in detail.

Each of the tape guides 441 and 442 has a hollow cylindrical shape. The tape guide 441 is fitted over the shaft 961 on the partition plate 21M, and the tape guide 442 is fitted over the shaft 962 on the partition plate 21M. The tape guides 441 and 442 are rotatable about the shafts 961 and 962, respectively.

The case 22 includes plates 22U, 22F, 22B, 22R, and 22L. Each of the plates 22U, 22F, 22B, 22R, and 22L has a rectangular shape. The plate 22U extends both in the front-rear direction and in the left-right direction (i.e., in the second direction and in the third direction). The plates 22F and 22B extend in the second direction. The plates 22L and 22R extend in the third direction.

The plate 22U includes shafts 26 to 29. Each of the shafts 26 to 29 extends in the first direction from the plate 22U. Each of the shafts 26 to 29 has a hollow cylindrical shape. The shafts 26 to 29 have outer shapes that are different from one another.

The shaft 26 is disposed on a corner portion of the plate 22U. The shaft 27 is disposed at a position offset from a center of the plate 22U. The shaft 28 is disposed at a position offset from the center of the plate 22U. The shaft 29 is disposed at a position offset from the center of the plate 22U.

The plate 22F is positioned on an edge of the plate 22U. The plate 22B is positioned on another edge of the plate 22U. The plate 22R is positioned on another edge of the plate 22U. The plate 22L is positioned on another edge of the plate 22U.

A first opening 16 is formed in an end portion of the housing 20.

A second space S2 is defined by the cases 21 and 22. The second space S2 is a three-dimensional space enclosed by the partition plate 21M and the plates 21F, 21B, 21L, and 21R of the case 21 and the plates 22U, 22F, 22B, 22L, and 22R of the case 22.

The drive transmission mechanism 30 is positioned in the second space S2. The drive transmission mechanism 30 is configured to transmit a drive force received through the transmission gear 679, which is disposed on the third shaft 66E of the drive shaft 63, to the platen roller 82. The drive transmission mechanism 30 is configured to also transmit the drive force received through the transmission gear 679 to the ribbon take-up spool 57.

The drive transmission mechanism 30 includes the first gear 34, the second gear 31, a third gear 37, and the fourth gear 32. The shaft 28 of the plate 22U is inserted in the first gear 34. The shaft 26 of the plate 22U is inserted in the second gear 31. The shaft 27 of the plate 22U is inserted in the third gear 37. The shaft 29 of the plate 22U is inserted in the fourth gear 32.

The first gear 34, the second gear 31, the third gear 37, and the fourth gear 32 are rotatable about the first axis L1, a second axis L2, a third axis L3, and the fourth axis L4, respectively. Each of the first axis L1, the second axis L2, the third axis L3, and the fourth axis L4 extends in the first direction.

The first gear 34 is coupled to the second gear 31 via the third gear 37. The first gear 34 is configured to transmit a drive force to the second gear 31. The first axis L1 of the first gear 34 is coaxial with the second rotational axis of the tape spool 47.

The first gear 34 includes a gear 35, and a first cam 36. The gear 35 and the first cam 36 are rotatable about the first axis L1. The gear 35 is an external gear in meshing engagement with a gear 38 (described later) of the third gear 37.

The first cam 36 is fixed to the gear 35. The first cam 36 is a hollow cylindrical internal gear with splines disposed on an inner circumferential surface of the first cam 36. The first cam 36 of the first gear 34 is exposed to the outside of the housing 20 through the third opening 23H and the opening 48. In other words, the first cam 36 is visible from the outside of the housing 20 through the third opening 23H and the opening 48. The third shaft 66E of the drive shaft 63 is configured to be inserted in the first cam 36 through the third opening 23H and the opening 48.

The second gear 31 is an external gear. The second gear 31 is configured to mesh with the platen gear 83. The second gear 31 is configured to transmit a drive force to the platen gear 83 for conveying the tape 40.

The second gear 31 is a so-called helical gear. The second gear 31 has gear teeth that are helical (i.e., skewed) at a prescribed angle relative to the second axis L2. The gear teeth on the second gear 31 are of the opposite hand to the gear teeth on the platen gear 83. The second axis L2 of the second gear 31 is parallel to the axis L8 of the platen gear 83.

The second gear 31 is exposed to an outside of the tape cassette 100A (i.e., the outside of the housing 20) through the first opening 16. Specifically, the gear teeth on the second gear 31 are partially exposed to a space in communication with the head opening 24. In the state where the tape cassette 100A is attached to the cassette attachment portion 10, the second gear 31 meshes with the platen gear 83 in the space in communication with the head opening 24.

The third gear 37 is configured to transmit a drive force inputted into the first gear 34 to the second gear 31 while reducing a rotational speed of the drive force. That is, the drive transmission mechanism 30 includes a reduction mechanism.

The third gear 37 is in meshing engagement with both the first gear 34 and the second gear 31. The third gear 37 is configured to transmit a drive force inputted into the first gear 34 to both the second gear 31 and the fourth gear 32.

The third gear 37 is a double gear including the gear 38 and a gear 39. The gears 38 and 39 are arranged side by side and coaxial with the third axis L3. A diameter of the gear 39 is smaller than a diameter of the gear 38. The gear 38 is positioned closer to the tape roll 41 than the gear 39 is to the tape roll 41 in the first direction.

The gear 38 is in meshing engagement with the first gear 34. The gear 38 is an external spur gear.

The gear 39 is in meshing engagement with the second gear 31. The gear 39 is an external helical gear. The gear 39 has gear teeth which are of the opposite hand to the gear teeth on the second gear 31.

The fourth gear 32 is in indirect engagement with the first gear 34 via the third gear 37. The fourth gear 32 is coupled to the ribbon take-up spool 57 through the opening 77. The fourth gear 32 is configured to transmit a drive force of the motor 61 to the ribbon take-up spool 57.

The fourth gear 32 includes a gear 33, a shaft 332, and a cam 331. The gear 33 is an external gear. The gear 33 is in meshing engagement with the gear 38 of the third gear 37. The shaft 332 is disposed on a center of the gear 33. The shaft 332 extends in the first direction from the gear 33. A rotational axis of the shaft 332 is the fourth axis L4.

The cam 331 extends in the first direction from the gear 33. The cam 331 has a hollow cylindrical shape. A plurality of recesses 333 are formed in one end of the cam 331 on the other side in the first direction. The recesses 333 are formed at prescribed intervals. The recesses 333 are recessed from the one end of the cam 331 on the other side in the first direction toward one end of the cam 331 on the one side in the first direction.

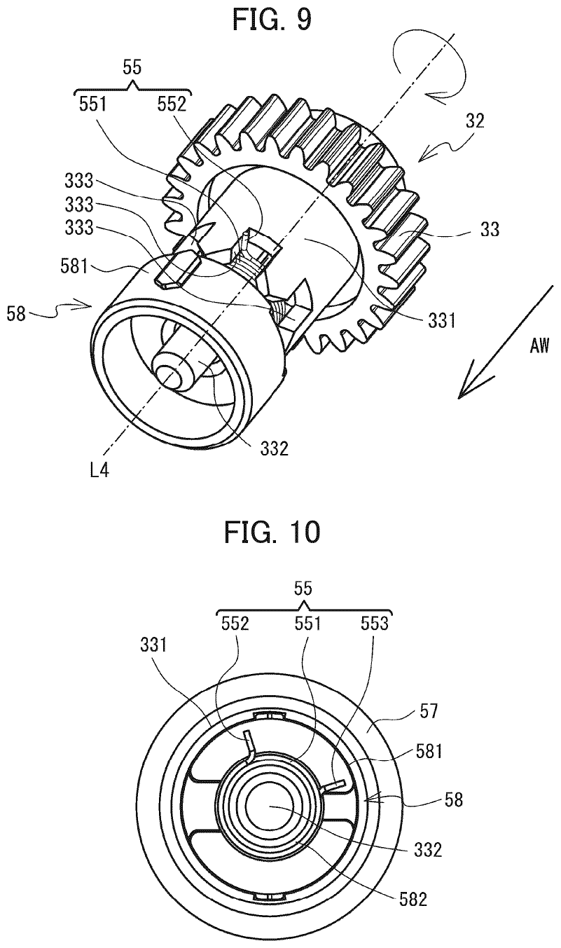

As illustrated in FIGS. 9 through 11, the torque limiter 58 is inserted in the cam 331. The torque limiter 58 is a component configured to transmit a drive force by coupling the drive-side fourth gear 32 and the driven-side ribbon take-up spool 57 to each other. The torque limiter 58 is configured to slip when the torque transmitted from the fourth gear 32 to the ribbon take-up spool 57 exceeds a certain magnitude. This configuration restricts excessive torque from being transmitted to the ribbon take-up spool 57.

The torque limiter 58 includes an enclosure 581, a shaft 582, and a spring 55.

The enclosure 581 has a hollow cylindrical shape. The enclosure 581 is fitted inside the ribbon take-up spool 57 so as not to be rotatable relative to the same.

The shaft 582 extends in the first direction from the enclosure 581. The shaft 582 has a hollow area. The shaft 332 of the gear 33 is inserted in the shaft 582.

The spring 55 includes a body 551, a first arm 552, and a second arm 553. An inner diameter of the body 551 is smaller than an outer diameter of the shaft 582. The body 551 is mounted over an outer circumference of the shaft 582. The first arm 552 of the spring 55 is seated in one of the recesses 333 of the cam 331. The second arm 553 of the spring 55 does not contact the cam 331 but is positioned to move freely relative to the same.

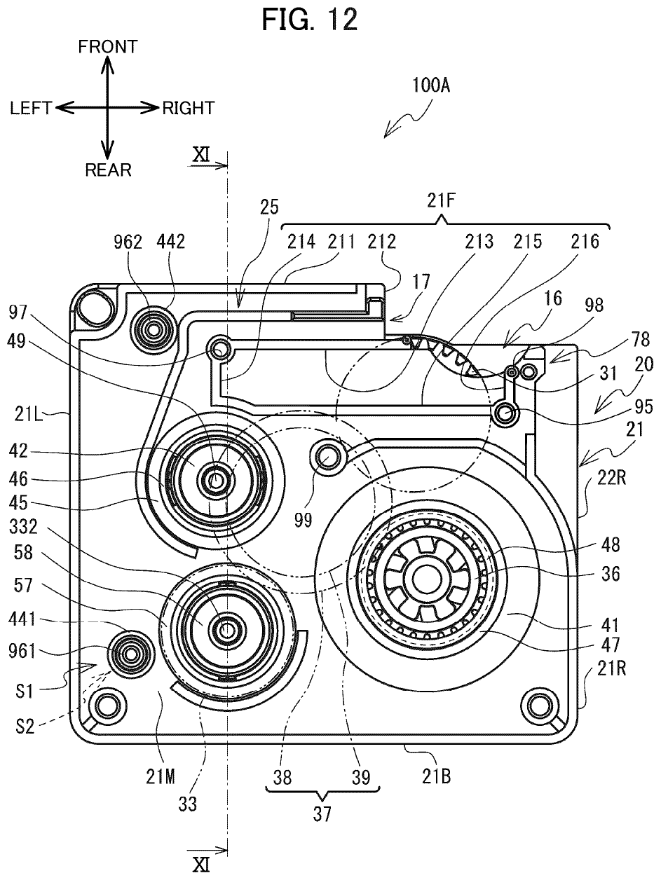

As illustrated in FIG. 12, a part of the second gear 31 overlaps a part of the tape roll 41 in the first direction (i.e., when viewed in the first direction). The third gear 37 overlaps both a part of the tape roll 41 and a part of the ribbon spool 46 in the first direction (i.e., when viewed in the first direction).

Next, printing operations performed on the printer 1 will be described with reference to FIG. 13. In order to perform printing on the tape 40, the tape cassette 100A is attached to the cassette attachment portion 10. At this time, the print head 71 is inserted into the head opening 24 to be positioned at a position overlapping the tape 40 and the ink ribbon 43 in the third direction (i.e., when viewed in the third direction).

The third shaft 66E of the drive shaft 63 is inserted into the first cam 36 of the first gear 34 accommodated in the second space S2. Upon mounting the cover 3 on the housing 2, the platen roller 82 moves to the adjacent position, whereby the platen gear 83 meshes with the second gear 31.

As the motor 61 is driven, the third shaft 66E of the drive shaft 63 rotates to cause the gear 35 of the first gear 34 to rotate together with the first cam 36. The rotation of the first gear 34 rotates the third gear 37, thereby rotating the second gear 31.

The rotation of the second gear 31 rotates the platen gear 83. Consequently, the platen roller 82 of the printer 1 rotates. The rotation of the platen roller 82 draws the tape 40 off the tape roll 41. The tape spool 47 rotates as the platen roller 82 conveys the tape 40.

The tape 40 that has been drawn off the tape roll 41 is guided to the second opening 17 in the arm 25 by the tape guides 441 and 442. The tape 40 is then discharged to the outside of the tape cassette 100A through the second opening 17 and is conveyed to the head opening 24.

In the meantime, the rotation of the third gear 37 also rotates the fourth gear 32, whereby the cam 331 of the fourth gear 32 rotates. Through the rotation of the cam 331, a torque from the first arm 552 and the second arm 553 of the spring 55 is applied to the torque limiter 58. Accordingly, a torque is transmitted from the fourth gear 32 to the ribbon take-up spool 57 via the torque limiter 58, thereby rotating the ribbon take-up spool 57 and causing the ink ribbon 43 to be taken up by the ribbon take-up spool 57.

The rotation of the platen roller 82 also draws the ink ribbon 43 off the ribbon roll 45. The ribbon spool 46 rotates as the ink ribbon 43 is drawn off.

The ink ribbon 43 that has been drawn off the ribbon roll 45 passes through an inside of the arm 25 to be guided to the second opening 17 by the first ribbon guide 97. The ink ribbon 43 is then discharged to the outside of the tape cassette 100A through the second opening 17 and is conveyed to the head opening 24.

In the head opening 24, the platen roller 82 presses the tape 40 against the print head 71 through the ink ribbon 43. In this state, the selected one or more heating elements 71A of the print head 71 are heated, whereby some ink on the ink ribbon 43 is transferred onto the tape 40. As a result, characters, figures, and the like are printed on the tape 40.

The platen roller 82 conveys the tape 40 on which printing has been performed from an inside of the tape cassette 100A toward the discharge channel 9.

In the meantime, the second ribbon guide 98 guides the used ink ribbon 43 to the ribbon take-up spool 57. Specifically, the ink ribbon 43 is guided to the first space S1 by the second ribbon guide 98. The ink ribbon 43 subsequently passes over the second ribbon guides 95 and 99 and is taken up on the ribbon take-up spool 57.

After printing is completed, the user operates the cutter to separate the tape 40 that has passed through the discharge channel 9 of the printer 1 from the printer 1.

While the ink ribbon 43 is taken up, the torque applied from the fourth gear 32 to the ribbon take-up spool 57 through the torque limiter 58 may exceed a predetermined value. In this case, the torque limiter 58 slips between the fourth gear 32 and the ribbon take-up spool 57 to relieve some of the torque which is transmitted from the fourth gear 32 to the ribbon take-up spool 57. This operation restricts the ink ribbon 43 from being stretched or broken due to excessive tension acting on the ink ribbon 43 as the ink ribbon 43 is taken up.

As described above, the tape cassette 100A includes the housing 20. The housing 20 includes the partition plate 21M. The partition plate 21M partitions an internal space of the housing 20 into the first space S1 and the second space S2. The first space S1 and the second space S2 are arranged in the first direction. The tape roll 41 and the ribbon spool 46 are positioned in the first space S1. The first gear 34 is positioned in the second space S2. The first gear 34 is configured to transmit a drive force to the ribbon take-up spool 57. The second gear 31 is also positioned in the second space S2. The second gear 31 is configured to operate in response to an operation of the first gear 34.

In the tape cassette 100A described above, the first gear 34, the second gear 31, the third gear 37, and the fourth gear 32 are positioned in the second space S2. Hence, the tape cassette 100A can secure a space for accommodating the first gear 34, the second gear 31, the third gear 37, and the fourth gear 32.

The tape guides 441 and 442 are configured to guide the tape 40 toward the second opening 17. Therefore, the tape cassette 100A can convey the tape 40 smoothly using the tape guides 441 and 442.

The first ribbon guide 97 is configured to guide the ink ribbon 43 toward the second opening 17. With the first ribbon guide 97, the tape cassette 100A can convey the ink ribbon 43 smoothly.

The second ribbon guide 98 is configured to guide the ink ribbon 43 toward the ribbon take-up spool 57. With the second ribbon guide 98, the tape cassette 100A can convey the ink ribbon 43 smoothly.

The housing 20 has the third opening 23H. The third opening 23H is in communication with the first space S1. The first gear 34 includes the first cam 36. The first cam 36 is exposed to the outside of the housing 20 through the third opening 23H. In other words, the first cam 36 is visible from outside the housing 20 through the third opening 23H. Through the third opening 23H, the tape cassette 100A facilitates the insertion of a member for driving the first cam 36.

The third gear 37 is positioned in the second space S2. The third gear 37 is in meshing engagement with both the first gear 34 and the second gear 31. The tape cassette 100A facilitates the transmission of a drive force between the first gear 34 and the second gear 31 using the third gear 37.

The third gear 37 is a double gear. The third gear 37 includes the gear 38 in meshing engagement with the first gear 34, and the gear 39 in meshing engagement with the second gear 31. By using a double gear, the tape cassette 100A facilitates the transmission of a drive force between the first gear 34 and the second gear 31 while changing an operating speed.

The second gear 31 is a helical gear. Through a thrust force generated on the helical gear, the tape cassette 100A can restrict the tape 40 conveyed in the tape cassette 100A from moving in the width direction of the tape 40. When a drive force is transmitted from the second gear 31 to the platen gear 83 mounted on the platen roller 82 in the printer 1, a thrust force is generated on the second gear 31. This thrust force has a direction for pushing the tape cassette 100A into the printer 1.

The fourth gear 32 is positioned in the second space S2. The fourth gear 32 is configured to operate in response to the operation of the first gear 34. The torque limiter 58 connects the fourth gear 32 and the ribbon take-up spool 57 to each other. The torque limiter 58 is configured to slip when the torque transmitted to the fourth gear 32 exceeds a predetermined value. Thus, the tape cassette 100A can restrict stretching and breakage of the ink ribbon 43.

The first gear 34 is rotatable about the first axis L1. The second gear 31 is rotatable about the second axis L2. The tape cassette 100A can convey the tape 40 and the ink ribbon 43 by transmitting a drive force through the rotation of the first gear 34 and the second gear 31.

A part of the gear teeth of the second gear 31 is exposed to the outside of the housing 20 through the first opening 16. By exposing some of the gear teeth on the second gear 31 to the outside of the housing 20 through the first opening 16, the tape cassette 100A can reliably transmit a drive force externally.

The tape 40 is wound about the tape spool 47 to form the tape roll 41. Since the tape 40 is wound about the tape spool 47, the tape cassette 100A can convey the tape 40 stably.

The first gear 34 overlaps the tape roll 41 in the first direction (i.e., when viewed in the first direction). Therefore, the tape cassette 100A can make the housing 20 more compact.

The third gear 37 overlaps both the tape roll 41 and the ribbon spool 46 in the first direction (i.e., when viewed in the first direction). Therefore, the tape cassette 100A can make the housing 20 more compact.

In the present embodiment, the first rotational axis L21 is an example of the “first axis”; the up-down direction is an example of the “first direction”; the first ribbon guide 97 is an example of the “ribbon guide configured to guide the ink ribbon toward the second opening”; the second ribbon guides 95, 98, and 99 are each an example of the “ribbon guide configured to guide the ink ribbon toward the ribbon take-up spool”; the first cam 36 is an example of the “cam”; the third gear 37 is an example of the “double gear”; the gear 38 is an example of the “third gear in meshing engagement with the first gear”; the gear 39 is an example of the “fourth gear in meshing engagement with the second gear”; the fourth gear 32 is an example of the “third gear configured to operate in response to the operation of the first gear”; the first axis L1 is an example of the “second axis”; and the second axis L2 is an example of the “third axis”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art.

Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:
In the above embodiment, the housing 20 has the configuration illustrated in FIG. 7 but is not limited to this configuration. The configuration of the housing 20 and the layout of the components in the housing 20 may be modified as appropriate. The shapes of the cases 21, 22, and 23 may also be modified as appropriate.

In the above embodiment, the internal space of the housing 20 is partitioned at the position of the partition plate 21M illustrated in FIG. 7, but is not limited to this configuration. The position of the partition plate 21M may be modified as appropriate. A size of the internal space may be adjusted according to the dimensions of the tape 40, the ink ribbon 43, and the drive transmission mechanism 30.

In the above embodiment, the drive transmission mechanism 30 includes the first gear 34, the second gear 31, the third gear 37, and the fourth gear 32, but is not limited to this configuration. For example, the third gear 37 may be dispensed with. In this case, the gear 35 of the first gear 34 is in direct meshing engagement with both the second gear 31 and the fourth gear 32. The dimensions of the first gear 34, the second gear 31, the third gear 37, and the fourth gear 32 may also be modified as appropriate, for example.

Although the third gear 37 is a double gear in the above embodiment, the third gear 37 may be a single gear.

In the above embodiment, the drive transmission mechanism 30 includes the first gear 34 rotatable about the first axis L1, the second gear 31 rotatable about the second axis L2, and the gear 38 rotatable about the third axis L3. However, the drive transmission mechanism 30 need not be limited to this configuration.

For example, the drive transmission mechanism 30 may be configured to transmit a drive force using spur gears, helical gears, external gears, internal gears, worm gears and worm wheels, for example.

The drive transmission mechanism 30 may also be configured to transmit a drive force using components other than gears rotatable about an axis, such as toothed belts and toothed pulleys, bevel gears and drive shafts, rack and pinion mechanisms.

In the above embodiment, the shafts 26 to 29 are disposed on the plate 22U of the case 22, but are not limited to this layout. For example, the shafts 26 and 27 may be disposed on the partition plate 21M of the case 21. The positional relationships of the shafts 26 to 29 may be adjusted as appropriate according to the dimensions of the first gear 34, the second gear 31, the third gear 37, and the fourth gear 32.

In the above embodiment, the shafts 961 and 962 and the tape guides 441 and 442 are positioned on the partition plate 21M of the case 21, but are not limited to this layout. For example, the shafts 961 and 962 may be disposed on the plate 23D of the case 23. The shafts 961 and 962 can be disposed anywhere as long as the tape guides 441 and 442 can be disposed at positions for guiding the tape 40 in the first space S1.

In the above embodiment, the tape 40 is wound about the tape spool 47 to form the tape roll 41, but the tape roll 41 is not limited to this configuration. For example, the tape roll 41 is formed solely of the tape 40 wound into a roll. In other words, the tape spool 47 may be omitted.

In the above embodiment, the ink ribbon 43 is wound about the ribbon spool 46 to form the ribbon roll 45, but the ribbon roll 45 is not limited to this configuration. For example, the ribbon roll 45 may be formed solely of the ink ribbon 43 wound into a roll. In other words, the ribbon spool 46 may be omitted.

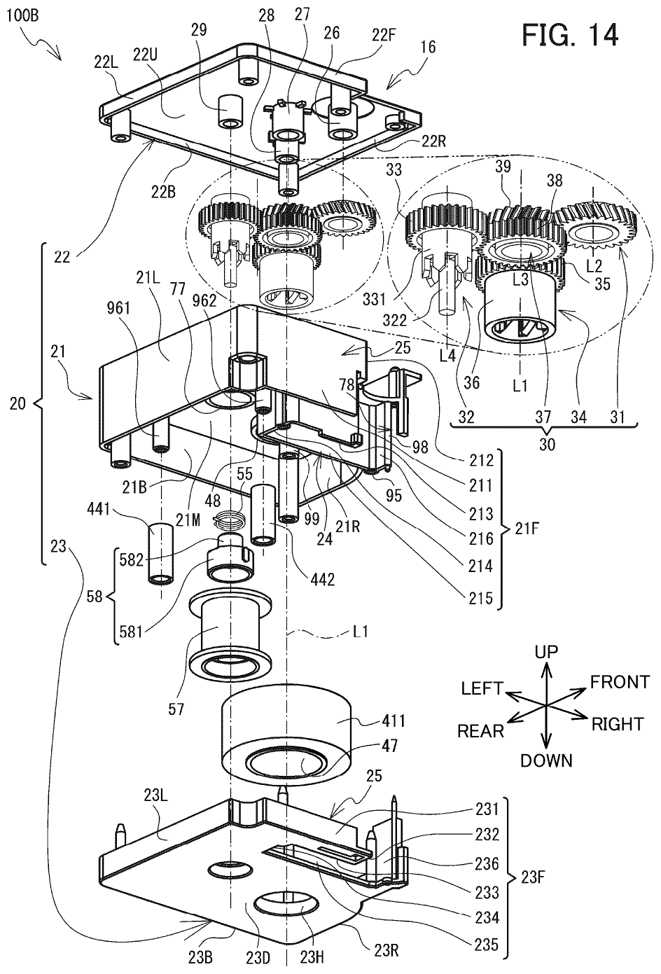

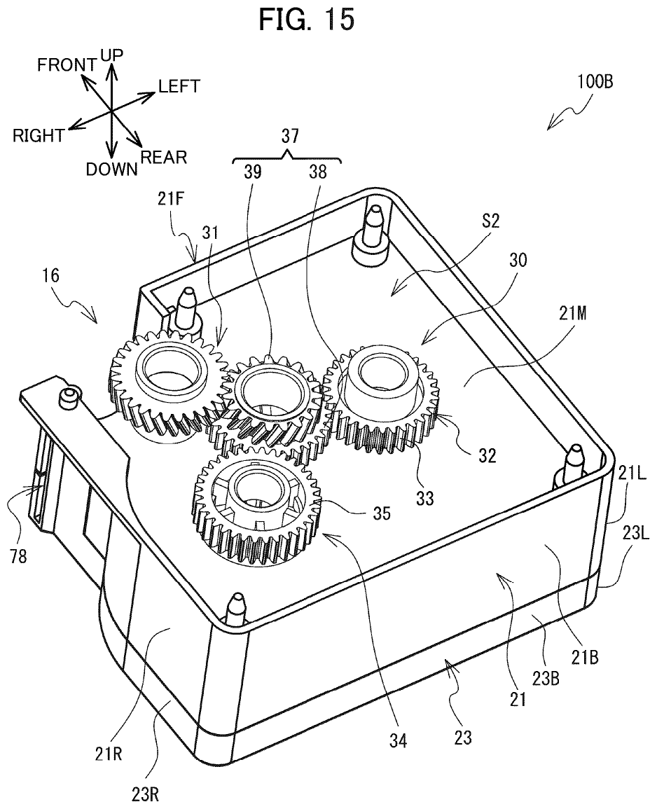

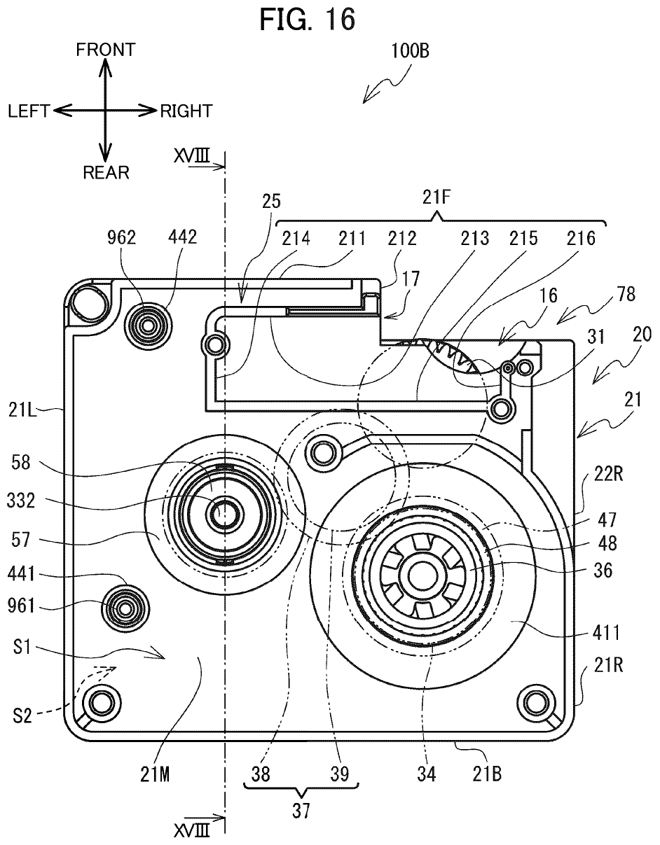

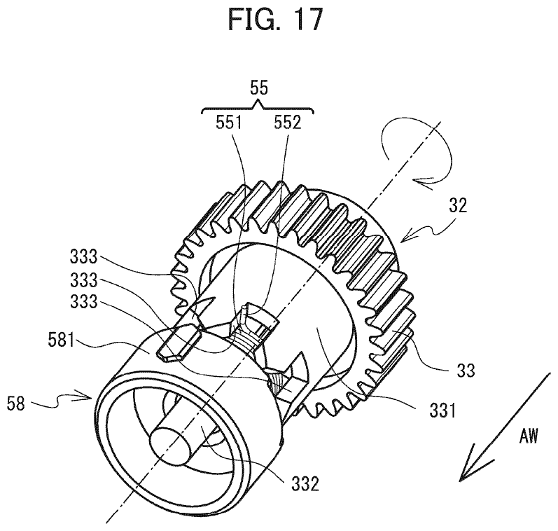

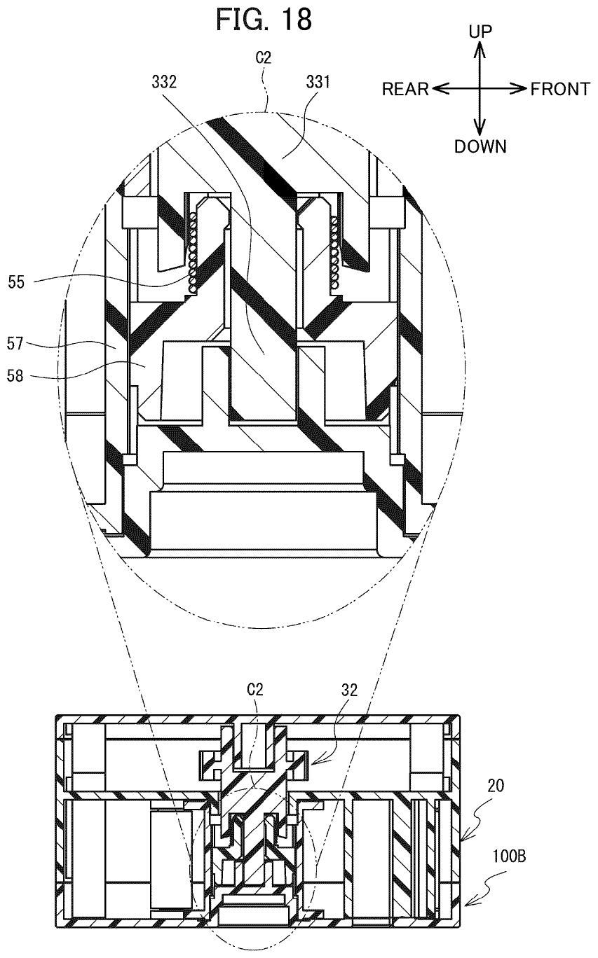

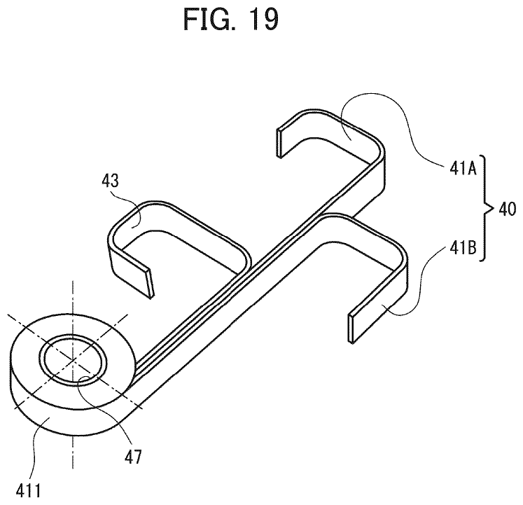

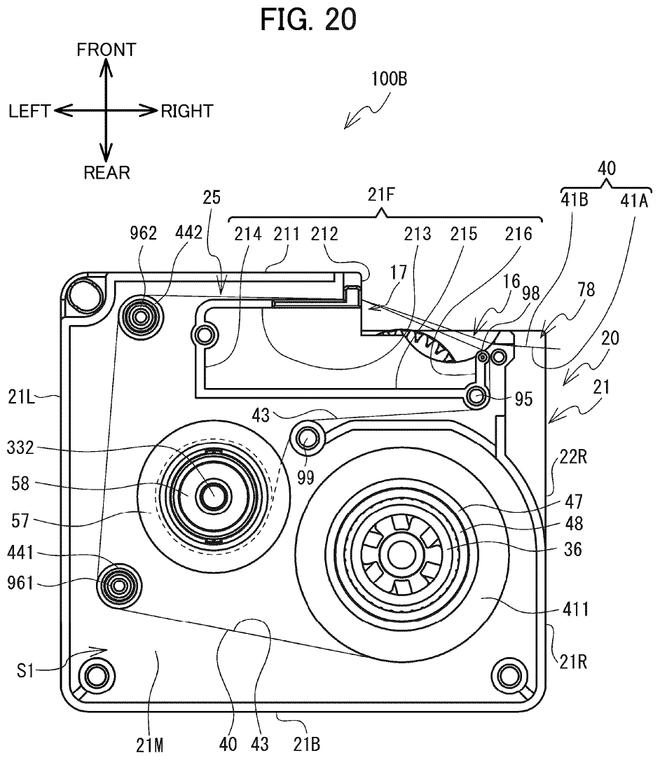

A tape cassette 100B according to a first modification will be described with reference to FIGS. 14 through 20. Note that components of the tape cassette 100B having the same function as those in the tape cassette 100A according to the above embodiment are designated with the same reference numerals. The following description will focus on the parts that differ from the tape cassette 100A.

In the first modification, a tape roll 411 illustrated in FIG. 19 is accommodated in the tape cassette 100B in place of the tape roll 41 accommodated in the tape cassette 100A. The tape roll 411 is a roll in which the ink ribbon 43 and the tape 40 are wound together in an overlaid state. That is, the ink ribbon 43 and the tape 40 are wound about the tape spool 47 to form the tape roll 411. The tape 40 includes a printing tape 41A, and a release paper 41B bonded to the printing tape 41A.

Unlike the tape cassette 100A, the tape cassette 100B does not include the ribbon spool 46, the holder 42, the shaft 49, and the first ribbon guide 97 since the ink ribbon 43 is not supplied from a ribbon roll 45.

The layout of the ribbon take-up spool 57, the torque limiter 58, and the opening 77 are also different from those in the above embodiment. The ribbon take-up spool 57, the torque limiter 58, and the opening 77 are arranged at positions leftward of a center of the tape cassette 100B.

Printing operations performed on the printer 1 will be described. When printing is performed, the drive transmission mechanism 30 rotates the platen roller 82, which draws the tape 40 and the ink ribbon 43 off the tape roll 411.

The tape 40 and the ink ribbon 43 are guided to the second opening 17 in the arm 25 by the tape guides 441 and 442. The tape 40 and the ink ribbon 43 are conveyed through the second opening 17 into the head opening 24.

In the head opening 24, the platen roller 82 presses the tape 40 against the print head 71 through the ink ribbon 43. The print head 71 prints characters, figures, and the like on the tape 40.

The tape 40 on which printing has been completed passes through the guide 78 and is discharged to the outside of the printer 1 through the discharge channel 9 of the printer 1.

In the meantime, since the rotation of the third gear 37 also causes the fourth gear 32 to rotate, the cam 331 rotates together along with the rotation of the fourth gear 32. The rotation of the cam 331 causes the ribbon take-up spool 57 to rotate together with the torque limiter 58.

The ink ribbon 43 that has been used for printing is guided into the first space S1 of the housing 20 by the second ribbon guide 98. The ink ribbon 43 passes over the other second ribbon guides 95 and 99 and is taken up by the ribbon take-up spool 57.

After printing is completed, the user operates the cutter to separate the printed tape 40 from the printer 1.

As described above, the tape cassette 100B includes the tape roll 411 and the ribbon take-up spool 57. The tape roll 411 is a roll in which the tape 40 and the ink ribbon 43 wound together in an overlaid state. The tape roll 411 is positioned in the first space S1. The ribbon take-up spool 57 is configured to take up the ink ribbon 43. The tape cassette 100B further includes the first gear 34 and the second gear 31. The first gear 34 is positioned in the second space S2, and is configured to transmit a drive force to the ribbon take-up spool 57. The second gear 31 is also positioned in the second space S2, and is configured to operate in response to the operation of the first gear 34.

In the tape cassette 100B described above, the first gear 34 and the second gear 31 are positioned in the second space S2. Therefore, the tape cassette 100B can secure a space for accommodating the first gear 34 and the second gear 31.

The tape guides 441 and 442 are configured to guide the tape 40 and the ink ribbon 43 toward the second opening 17. Hence, with the tape guides 441 and 442, the tape cassette 100B can convey the tape 40 and the ink ribbon 43 smoothly.

The second ribbon guide 98 is configured to guide the ink ribbon 43 toward the ribbon take-up spool 57. With the second ribbon guide 98, the tape cassette 100B facilitates the smooth conveyance of the ink ribbon 43.

The tape cassette 100B in the first modification includes components having the same functions as those in the tape cassette 100A. Therefore, the tape cassette 100B in the first modification obtains the same advantages as the embodiment to the extent that there is no contradiction.

The modifications of the tape cassette 100A in the above embodiment can also be applied to the tape cassette 100B in the first modification as long as there are no contradictions.

In the first modification, the third rotational axis and the fourth axis L4 are each an example of the “first axis”; the up-down direction is an example of the “first direction”; the second ribbon guides 95, 98, and 99 are each an example of the “ribbon guide”; the first cam 36 is an example of the “cam”; the third gear 37 is an example of the “double gear”; the gear 38 is an example of the “third gear in meshing engagement with the first gear”; the gear 39 is an example of the “fourth gear in meshing engagement with the second gear”; the fourth gear 32 is an example of the “third gear configured to operate in response to the operation of the first gear; the first axis L1 is an example of the “second axis”; and the second axis L2 is an example of the “third axis”.

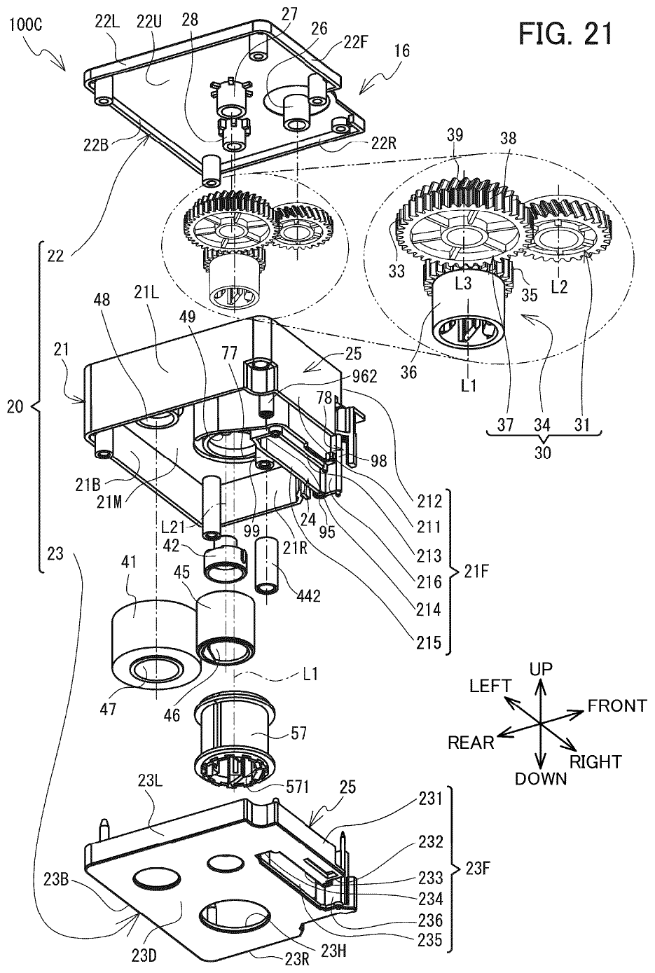

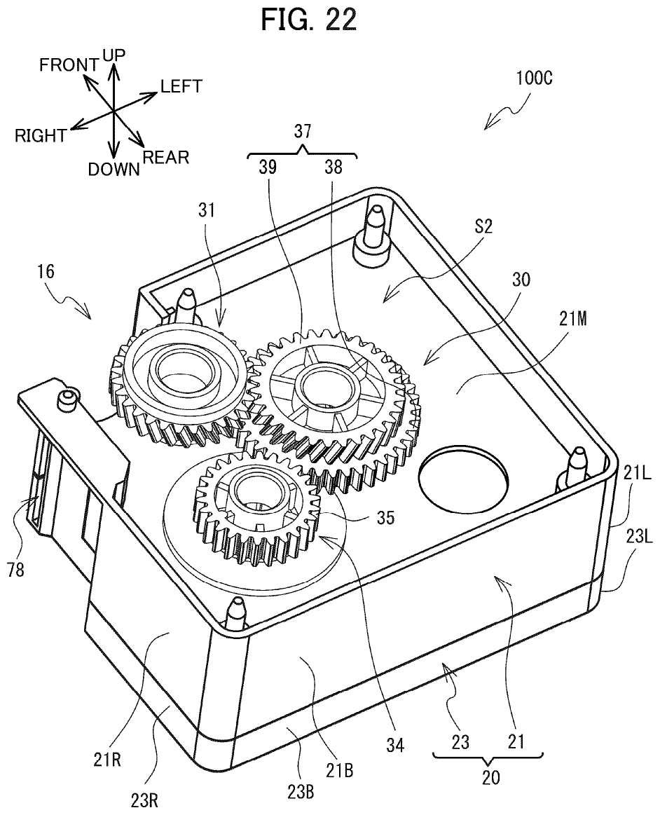

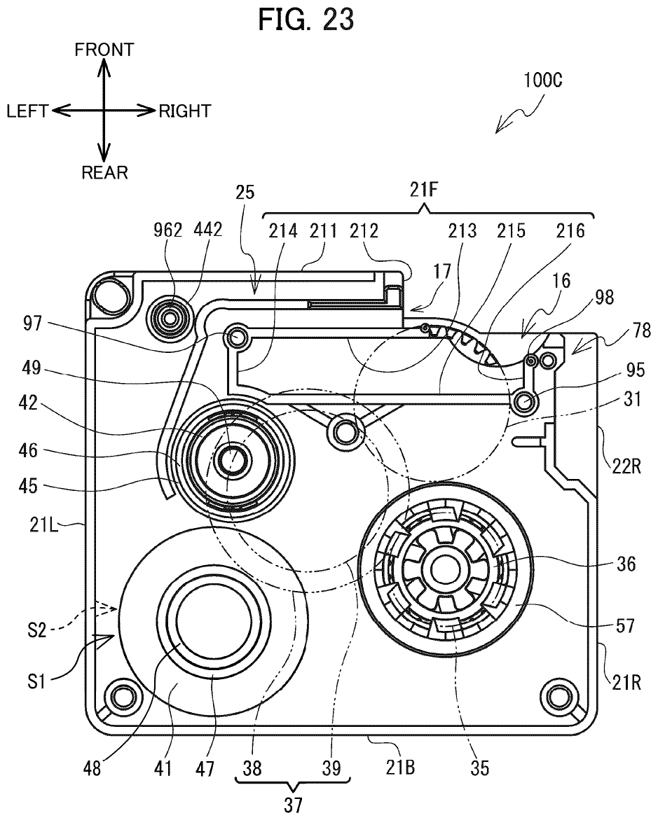

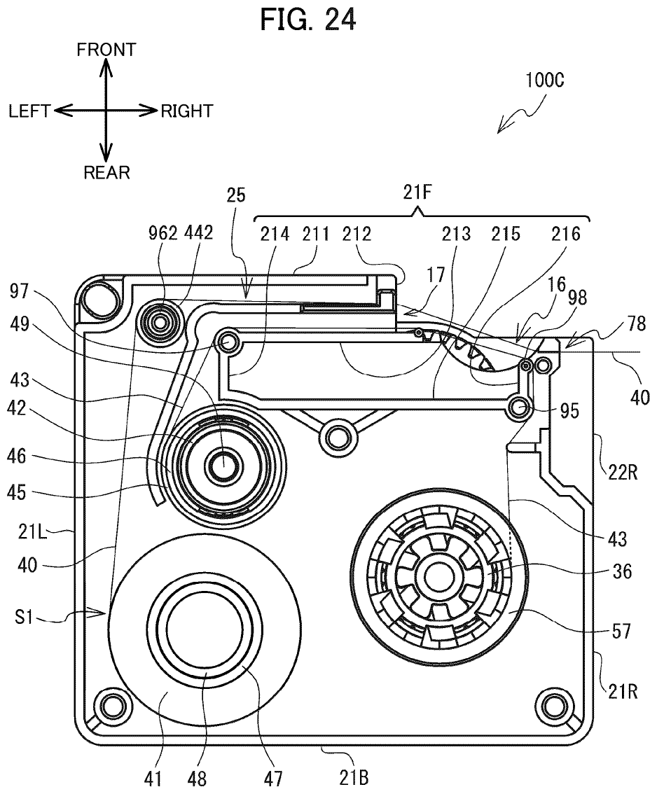

Next, a tape cassette 100C according to a second modification will be described with reference to FIGS. 21 through 24. Note that components of the tape cassette 100C having the same function as those in the tape cassette 100A in the embodiment are designated with the same reference numerals. The following description will focus on the parts that differ from the tape cassette 100A.

In the second modification, the layout of the tape roll 41 and the ribbon take-up spool 57 accommodated in the tape cassette 100C are different from that in the tape cassette 100A. Also, unlike the tape cassette 100A, the tape cassette 100C does not include the fourth gear 32, the second ribbon guide 99, nor the shaft 29.

The tape roll 41 is arranged in a left-rear corner of the tape cassette 100C. Consequently, the opening 48 is also formed in a left-rear corner of the partition plate 21M. Therefore, the shaft 961 and the tape guide 441, which are arranged in the left-rear corner of the tape cassette 100A, are dispensed with.

The ribbon take-up spool 57 is disposed at a position diagonally rightward and rearward of a center of the tape cassette 100C. Accordingly, the opening 77 is formed at a position diagonally rightward and rearward of the center of the partition plate 21M. The position of the ribbon take-up spool 57 corresponds to the position of the tape roll 41 in the tape cassette 100A. In other words, the rotational axis of the ribbon take-up spool 57 in the second modification is coaxial with the first axis L1 of the first gear 34.

The ribbon take-up spool 57 includes a second cam 571 at an inner circumferential surface of the ribbon take-up spool 57. The second cam 571 includes splines. The cam 67A of the drive cam 67 provided on the drive shaft 63 is configured to be coupled with the second cam 571. Therefore, the rotation of the drive shaft 63 rotates the ribbon take-up spool 57. In other words, the cam 67A is configured to directly transmit the drive force received from the drive gear 66 to the ribbon take-up spool 57.

As with the tape cassette 100A of the embodiment, the third shaft 66E of the drive shaft 63 rotates the first cam 36. In other words, the first gear 34 and the ribbon take-up spool 57 are directly driven by the rotation of the drive shaft 63 in the tape cassette 100C according to the second modification.

Printing operations on the printer 1 will be described. In a state where the tape cassette 100C is attached to the cassette attachment portion 10, the third shaft 66E of the drive shaft 63 is inserted in the first cam 36. At the same time, the drive cam 67 of the drive shaft 63 is coupled with the second cam 571 of the ribbon take-up spool 57.

When performing a printing operation, the third shaft 66E of the drive shaft 63 rotates the first cam 36, whereby the first gear 34 rotates in association with the first cam 36. Accordingly, the second gear 31 rotates via the third gear 37.

The rotation of the second gear 31 rotates the platen gear 83, which causes the platen roller 82 to rotate. The platen roller 82 draws out the tape 40 off the tape roll 41. The tape guide 442 guides the tape 40 to the second opening 17 in the arm 25, and the tape 40 is conveyed through the second opening 17 into the head opening 24.

In the meantime, as the drive shaft 63 is driven, the gear 66A of the drive gear 66 rotates, thereby rotating the shaft 65.

The clutch spring 68 transmits the drive force from the drive gear 66 to the drive cam 67 via the first arm 68B. In other words, the torque of the clutch spring 68 is applied to the drive cam 67, and the drive cam 67 rotates by the transmitted drive force.

The rotation of the platen roller 82 also draws the ink ribbon 43 off the ribbon roll 45. The ribbon spool 46 rotates as the platen roller 82 conveys the ink ribbon 43.

In the head opening 24, the platen roller 82 presses the tape 40 against the print head 71 through the ink ribbon 43. The print head 71 prints characters, figures, and the like on the tape 40.

The printed tape 40 passes through the guide 78 and is discharged through the discharge channel 9 of the printer 1.

After printing is completed, the user operates the cutter to separate the printed tape 40 from the printer 1.

In the meantime, the rotation of the drive cam 67 rotates the second cam 571 of the ribbon take-up spool 57. As the ribbon take-up spool 57 rotates, the ink ribbon 43 is guided into the first space S1 in the housing 20 by the second ribbon guide 98. The ink ribbon 43 is further guided over the second ribbon guide 95 and taken up by the ribbon take-up spool 57.

As described above, the tape cassette 100C includes the tape roll 41, the ribbon spool 46, and the ribbon take-up spool 57. The tape roll 41 is a roll in which the tape 40 is wound. The ink ribbon 43 is wound about the ribbon spool 43. The ribbon take-up spool 57 is configured to take up the ink ribbon 43. The tape roll 41, the ribbon spool 46, and the ribbon take-up spool 57 are positioned in the first space S1. The tape cassette 100C further includes the first gear 34 and the second gear 31. The first gear 34 is positioned in the second space S2, and is configured to transmit a drive force to the ribbon take-up spool 57. The second gear 31 is also positioned in the second space S2, and is configured to operate in response to the operation of the first gear 34.

In the tape cassette 100C described above, the first gear 34 and the second gear 31 are positioned in the second space S2. Therefore, the tape cassette 100C can secure a space for accommodating the first gear 34 and the second gear 31.

The first cam 36 is rotatable together with the first gear 34 about the first axis L1. The second cam 571 is rotatable coaxially about the first axis L1. In the tape cassette 100C, the tape 40 and the ink ribbon 43 can be conveyed using the drive force due to the rotation of the first cam 36 and the second cam 571.

The first gear 34 overlaps the ribbon take-up spool 57 in the up-down direction (i.e., when viewed in the up-down direction). In other words, the first gear 34 overlaps the tape roll 41 when viewed in the first direction. Accordingly, the tape cassette 100C can make the housing 20 more compact.

The third gear 37 overlaps the tape roll 41, the ribbon spool 46, and the ribbon take-up spool 57 in the up-down direction (i.e., when viewed in the up-down direction). In other words, the third gear 37 overlaps the tape roll 41, the ribbon spool 46, and the ribbon take-up spool 57 when viewed in the first direction). Accordingly, the tape cassette 100C can make the housing 20 more compact.

Note that the second gear 31 may overlap the ribbon spool 46 in the up-down direction (i.e., when viewed in the up-down direction). In other words, the second gear 31 may overlap the ribbon spool 46 when viewed in the first direction.

The tape cassette 100C in the second modification includes components having the same functions as those in the tape cassette 100A. Therefore, the tape cassette 100C in the second modification can obtain the same advantages as those in the embodiment to the extent that there are no contradictions.

Note that the modifications of the above embodiment can be applied to the tape cassette 100C in the second modification as long as there are no contradictions.

In the second modification, the first rotational axis L21 is an example of the “first axis”; the up-down direction is an example of the “first direction”; the first ribbon guide 97 is an example of the “ribbon guide configured to guide the ink ribbon toward the second opening”; the second ribbon guides 95 and 98 are each an example of the “ribbon guide configured to guide the ink ribbon toward the ribbon take-up spool”; the third gear 37 is an example of the “double gear”; the gear 38 is an example of the “third gear in meshing engagement with the first gear”; the gear 39 is an example of the “fourth gear in meshing engagement with the second gear”; the first axis L1 is an example of the “second axis”; and the second axis L2 is an example of the “third axis”.

What is claimed is:

1. A tape cassette comprising:
a tape roll in which a tape is wound;
a ribbon spool about which an ink ribbon is wound, the ribbon spool being rotatable about a first axis extending in a first direction;
a ribbon take-up spool configured to take up the ink ribbon;
a housing having a first opening, the housing including:
a partition plate partitioning an internal space of the housing into a first space in which the tape roll and the ribbon spool are positioned and a second space, the first space and the second space being arranged in the first direction; and
an arm positioned on an opposite side of the partition plate from the first space in the first direction, the arm having a second opening allowing the tape and the ink ribbon to be discharged through the second opening to an outside of the housing;
a first gear positioned in the second space, the first gear being configured to transmit a drive force to the ribbon take-up spool; and
a second gear positioned in the second space, the second gear being exposed to the outside of the housing through the first opening, the second gear being configured to operate in response to an operation of the first gear.

2. The tape cassette according to claim 1, further comprising:
a tape guide configured to guide the tape toward the second opening.

3. The tape cassette according to claim 1, further comprising:
a ribbon guide configured to guide the ink ribbon toward the second opening.

4. The tape cassette according to claim 1, further comprising:
a ribbon guide configured to guide the ink ribbon toward the ribbon take-up spool.

5. The tape cassette according to claim 1,
wherein the housing further has a third opening in communication with the first space, and
wherein the first gear includes a cam, the cam being visible from outside the housing through the third opening.

6. The tape cassette according to claim 1, further comprising:
a third gear positioned in the second space, the third gear being in meshing engagement with both the first gear and the second gear.

7. The tape cassette according to claim 1, further comprising:
a double gear including:
a third gear in meshing engagement with the first gear; and
a fourth gear in meshing engagement with the second gear.

8. The tape cassette according to claim 1,
wherein the second gear is a helical gear.

9. The tape cassette according to claim 1, further comprising:
a third gear positioned in the second space, the third gear being configured to operate in response to the operation of the first gear; and
a torque limiter connecting the third gear and the ribbon take-up spool to each other, the torque limiter being configured to slip when a torque transmitted to the third gear exceeds a predetermined value.

10. The tape cassette according to claim 1,
wherein the first gear is rotatable about a second axis, and
wherein the second gear is rotatable about a third axis.

11. The tape cassette according to claim 1,
wherein the second gear has gear teeth, and
wherein a part of the gear teeth is exposed to the outside of the housing through the first opening.

12. The tape cassette according to claim 1, further comprising:
a tape spool about which the tape is wound to form the tape roll.

13. The tape cassette according to claim 1,
wherein the second gear overlaps the tape roll in the first direction.

14. The tape cassette according to claim 6,
wherein the third gear overlaps both the tape roll and the ribbon spool in the first direction.

15. A tape cassette comprising:
a tape roll in which a tape and an ink ribbon are wound together in an overlaid state;
a ribbon take-up spool rotatable about a first axis extending in a first direction, the ribbon take-up spool being configured to take up the ink ribbon;
a housing having a first opening, the housing including:
a partition plate partitioning an internal space of the housing into a first space in which the tape roll and the ribbon take-up spool are positioned and a second space, the first space and the second space being arranged in the first direction; and
an arm positioned on an opposite side of the partition plate from the first space in the first direction, the arm having a second opening allowing the tape and the ink ribbon to be discharged through the second opening to an outside of the housing;
a first gear positioned in the second space, the first gear being configured to transmit a drive force to the ribbon take-up spool; and
a second gear positioned in the second space, the second gear being exposed to the outside of the housing through the first opening, the second gear being configured to operate in response to an operation of the first gear.

16. The tape cassette according to claim 15, further comprising:
a tape guide configured to guide the tape and the ink ribbon toward the second opening.

17. The tape cassette according to claim 15, further comprising:
a ribbon guide configured to guide the ink ribbon toward the ribbon take-up spool.

18. The tape cassette according to claim 15,
wherein the housing further has a third opening in communication with the first space, and
wherein the first gear includes a cam, the cam being visible from outside the housing through the third opening.

19. The tape cassette according to claim 15, further comprising:
a third gear positioned in the second space, the third gear being in meshing engagement with both the first gear and the second gear.

20. The tape cassette according to claim 15, further comprising:
a double gear including:
a third gear in meshing engagement with the first gear; and
a fourth gear in meshing engagement with the second gear.

21. The tape cassette according to claim 15,
wherein the second gear is a helical gear.

22. The tape cassette according to claim 15, further comprising:
a third gear positioned in the second space, the third gear being configured to operate in response to the operation of the first gear; and
a torque limiter connecting the third gear and the ribbon take-up spool to each other, the torque limiter being configured to slip when a torque transmitted to the third gear exceeds a predetermined value.

23. The tape cassette according to claim 15,
wherein the first gear is rotatable about a second axis, and
wherein the second gear is rotatable about a third axis.

24. The tape cassette according to claim 15,
wherein the second gear has gear teeth, and
wherein a part of the gear teeth is exposed to the outside of the housing through the first opening.

25. The tape cassette according to claim 15, further comprising:
a tape spool about which the tape and the ink ribbon are wound to form the tape roll.

26. The tape cassette according to claim 15,
wherein the second gear overlaps the tape roll in the first direction.

27. The tape cassette according to claim 19,
wherein the third gear overlaps both the tape roll and the ribbon take-up spool in the first direction.

28. A tape cassette comprising:
a tape roll in which a tape is wound;
a ribbon spool about which an ink ribbon is wound, the ribbon spool being rotatable about a first axis extending in a first direction;
a ribbon take-up spool configured to take up the ink ribbon;
a housing having a first opening, the housing including:
a partition plate partitioning an internal space of the housing into a first space in which the tape roll, the ribbon spool, and the ribbon take-up spool are positioned and a second space, the first space and the second space being arranged in the first direction; and
an arm positioned on an opposite side of the partition plate from the first space in the first direction, the arm having a second opening allowing the tape and the ink ribbon to be discharged through the second opening to an outside of the housing;
a first gear positioned in the second space, the first gear being configured to transmit a drive force to the ribbon take-up spool, the first gear including a first cam; and
a second gear positioned in the second space, the second gear being exposed to the outside of the housing through the first opening, the second gear being configured to operate in response to an operation of the first gear,
wherein the housing further has a third opening in communication with the first space, and
wherein the first cam is visible from outside the housing through the third opening.

29. The tape cassette according to claim 28, further comprising:
a tape guide configured to guide the tape toward the second opening.

30. The tape cassette according to claim 28, further comprising:
a ribbon guide configured to guide the ink ribbon toward the second opening.

31. The tape cassette according to claim 28, further comprising:
a ribbon guide configured to guide the ink ribbon toward the ribbon take-up spool.

32. The tape cassette according to claim 28, further comprising:
a third gear positioned in the second space, the third gear being in meshing engagement with both the first gear and the second gear.

33. The tape cassette according to claim 28, further comprising:
a double gear including:
a third gear in meshing engagement with the first gear; and
a fourth gear in meshing engagement with the second gear.

34. The tape cassette according to claim 28,
wherein the second gear is a helical gear.

35. The tape cassette according to claim 28,
wherein the first gear is rotatable about a second axis, and
wherein the second gear is rotatable about a third axis.

36. The tape cassette according to claim 28,
wherein the first cam is rotatable about a second axis together with the first gear, and
wherein the ribbon take-up spool includes a second cam, the second cam being rotatable coaxially about the second axis.

37. The tape cassette according to claim 28,
wherein the second gear has gear teeth, and
wherein a part of the gear teeth is exposed to the outside of the housing through the first opening.

38. The tape cassette according to claim 28, further comprising:
a tape spool about which the tape is wound to form the tape roll.

39. The tape cassette according to claim 28,
wherein the first gear overlaps the ribbon take-up spool in the first direction.

40. The tape cassette according to claim 32,
wherein the third gear overlaps the tape roll, the ribbon spool, and the ribbon take-up spool in the first direction.
